(19) United States
(12) Patent Application Publication
(10) Pub. No.: US 2012/0315209 A1
(43) Pub. Date: Dec. 13, 2012

(54) METHODS AND SYSTEMS FOR TREATING WATER STREAMS

(75) Inventors: Thomas Karl Bisson, Plymouth, MA (US); Sam S. Jeppson, Worcester, MA (US); Javier Mingchen Wu, Acton, MA (US); Morton Orentlicher, New York, NY (US); Mark M. Simon, Wilbraham, MA (US); Stephen H. Brown, Spencer, MA (US)

(73) Assignee: ThermoEnergy Corporation, Worcester, MA (US)

(21) Appl. No.: 13/425,799

(22) Filed: Mar. 21, 2012

Related U.S. Application Data
(60) Provisional application No. 61/517,446, filed on Apr. 20, 2011.

(51) Int. Cl. C01C 1/02; C01C 1/24; B01J 19/00; C01C 1/28; B01J 7/00

(52) U.S. Cl. 423/352; 423/409; 422/148; 422/187; 423/545

(57) ABSTRACT

Methods and systems for treating wastewater and process water streams are provided. In some embodiments, the wastewater and/or process water to be treated contains a target chemical (e.g., ammonia and/or ammonium). The methods and systems described herein may include recovering the target chemical from the water stream and/or producing a desired product (e.g., a fertilizer such as an ammonium salt) from the target chemical. In one set of embodiments, a method of treating wastewater and/or process water involves introducing the water stream into a system that includes a combination of two or more of, or all of, a reverse osmosis system, a reaction and separation system (e.g., a vacuum distillation system or other suitable separation system), and a membrane reactor system.

### RELATED APPLICATIONS (UTILITY)

This application claims priority under 35 U.S.C. §119(e) to co-pending U.S. Provisional Application Ser. No. 60/517,446, filed Apr. 20, 2011, the contents of which are incorporated herein by reference.

### FIELD

Methods and systems for treating wastewater and process water are provided. In some embodiments, the methods and systems involve producing a desired product from a target chemical contained in the wastewater and/or process water.

### BACKGROUND

There is a growing need for systems and methods for treating water streams which aid in the recovery of target chemicals. Such recovery systems allow for reuse of the water and/or reduction in the amount of a target chemical which is present in the water stream downstream. For example, wastewater effluent discharge sources pose an ever increasing contamination threat to associated receiving bodies of water. Municipal wastewater treatment plants throughout the United States are currently faced with the difficult challenge of complying with increasingly stringent discharge limitations of various target chemicals.

One target chemical of interest for recovery from wastewater is ammonium/ammonia. If discharged directly in the wastewater effluent, ammonium/ammonia can be toxic to fish and other aquatic life at very low concentration levels. In addition, nitrification of ammonium/ammonia to nitrite and nitrate can occur naturally under the typical aerobic conditions of the receiving bodies of water. This nitrification process can create an oxygen deficiency that causes stress and possible death to the fish population.

Due to the toxicity issues with ammonium/ammonia, most treatment facilities practice biological nitrification of ammonia to nitrate prior to final effluent discharge, which in itself creates another problem. Being a nutrient, nitrate promotes plant growth and can cause algae blooms that are detrimental to the environment. If introduced into the drinking water supply, nitrate is also harmful to the human population. Some facilities attain some level of nitrogen removal via the biological denitrification of nitrate to nitrogen, e.g., using biological nutrient reduction (BNR) for safe release into the atmosphere; however, BNR can create a large amount of biosolids that are costly to transport and dispose. Most large municipal systems send the biosolids that contain dead bacteria and proteins (amino acids) to an anaerobic digester for volume reduction. The digester is typically downstream of the biological nutrient reduction. As the biosolids are digested, the amount of ammonia formation increases, e.g., from 25 to 5,000 mg/l or higher, depending on the digester technology used and the amount of amines present. In other instances, such as in systems involving agriculture biogas conversion to fuel or electricity, wastewater mixtures may be sent directly into an anaerobic digester for treatment without the initial BNR nitrification/dentrification step. Such applications may also involve high amounts of ammonium/ammonia or other chemicals.

Systems that would remove and/or recover ammonium/ammonia from waste streams, reduce the load of BNR, or replace BNR completely would not only alleviate a tremendous burden on these secondary treatment operations, but also significantly reduce the total nitrogen discharge of the wastewater treatment plant. Accordingly, improved methods and systems are needed.

### SUMMARY

Methods and systems for treating wastewater and process water are provided. In some embodiments, the methods and systems involve producing a desired product from a target chemical contained in the wastewater and/or process water. The subject matter of this application involves, in some cases, interrelated products, alternative solutions to a particular problem, and/or a plurality of different uses of and systems.

In one set of embodiments, a series of methods are provided. In one embodiment, a method for producing a desired product from wastewater or process water is provided. The method includes providing wastewater or process water comprising a target chemical and vaporizing at least a portion of the wastewater or process water to form a vapor portion, which vapor portion contains the target chemical and/or a chemically modified form thereof. The method also includes forming a first liquid solution containing the target chemical and/or the chemically modified form thereof, and introducing at least a portion of the first liquid solution into a first region of a membrane reactor system comprising the first region and a second region, wherein the first and second regions are separated by a membrane, and wherein the second region contains a second liquid solution comprising a reagent reactive with the target chemical and/or the chemically modified form thereof. The method involves reacting at least a portion of the target chemical and/or the chemically modified form thereof with the reagent to form the desired product in the second region of the membrane reactor system, and collecting the desired product.

In another embodiment, a method for producing an ammonium product from wastewater or process water is provided. The method involves providing wastewater or process water comprising ammonium and converting the ammonium to ammonia gas to form a solution comprising dissolved ammonia gas. The method also involves contacting the solution comprising the dissolved ammonia gas with an acid solution to form an ammonium salt solution, wherein the concentration of ammonium salt is greater than or equal to about 20 wt % immediately following the contacting step.

In another embodiment, a method for recovering ammonia from wastewater or process water is provided. The method involves increasing the temperature of wastewater or process water comprising ammonium to between about 160 F and about 200 F and adjusting the pH of the wastewater to between about 7.5 and 11, thereby converting a substantial portion of the ammonium to ammonia gas, forming a vapor portion containing a substantial portion of the ammonia gas from the wastewater in a vaporizer, wherein the vaporizer is operated at a pressure between about 6 and 21 inches Hg vacuum, and collecting the ammonia gas.

In another embodiment, a method for producing a desired product from wastewater or process water is provided. The method involves introducing wastewater or process water containing a target chemical into a reverse osmosis system and forming a retentate comprising a de-watered, more concentrated solution of the target chemical, and optionally converting the target chemical from the retentate into a chemically modified form thereof. The method involves introducing at least a portion of the retentate from the reverse osmosis system into a first region of a membrane reactor system comprising the first region and a second region, wherein the first and second regions are separated by a membrane, and wherein the second region contains a liquid solution comprising a reagent reactive with the target chemical and/or the chemically modified form thereof. The method also involves reacting at least a portion of the target chemical and/or the chemically modified form thereof with the reagent to form the desired product in the second region of the membrane reactor system, and collecting the desired product.

In another embodiment, a method for producing a chemically modified form of a target chemical from wastewater or process water is provided. The method involves introducing wastewater or process water containing a target chemical into a reverse osmosis system and forming a retentate comprising a de-watered, more concentrated solution of the target chemical, and converting a substantial portion of the target chemical in the retentate from the reverse osmosis system into a chemically modified form of the target chemical. The method involves vaporizing at least a portion of the retentate to form a vapor portion, which vapor portion contains the chemically modified form of the target chemical, and collecting the chemically modified form of the target chemical in a first solution.

In another set of embodiments, a series of systems or apparatuses is provided. In one embodiment, a system for recovering a desired product from wastewater or process water is provided. The system includes a vaporizer adapted and arranged to vaporize a portion of the wastewater or process water and produce a vapor stream containing a target chemical and/or the chemically modified form thereof and a condenser in fluid communication with the vaporizer and adapted and arranged to form a liquid solution containing the target chemical and/or the chemically modified form thereof. The system also includes a membrane reactor system in fluid communication with the gas collection system and comprising a first region and a second region, wherein the first and second regions are separated by a membrane and adapted to facilitate a reaction between the target chemical and/or the chemically modified form thereof and a reagent to form the desired product. This system also includes a collection system in fluid communication with the membrane reactor system and adapted and arranged to collect the desired product.

In another embodiment, an apparatus for producing a desired product from wastewater or process water is provided. The apparatus includes a reverse osmosis system adapted and arranged to concentrate and/or purify a target chemical in the wastewater or process water and form a retentate comprising a de-watered, more concentrated solution of the target chemical. The apparatus also includes a membrane reactor system in fluid communication with the reverse osmosis system and comprising a first region and a second region, wherein the first and second regions are separated by a membrane and adapted to facilitate a reaction between the target chemical and/or a chemically modified form thereof and a reagent to form the desired product in the second region. The apparatus further includes a collection system in fluid communication with the membrane reactor system and adapted and arranged to collect the desired product.

In another embodiment, an apparatus for producing a chemically modified form of a target chemical from wastewater or process water is provided. The apparatus includes a reverse osmosis system adapted and arranged to concentrate and/or purify a target chemical in wastewater or process water and form a retentate comprising a de-watered, more concentrated solution of the target chemical. The apparatus also includes a reaction and separation system adapted and arranged to convert a substantial portion of the target chemical into a vapor containing a chemically modified form of the target chemical, and a collection system adapted and arranged to collect the chemically modified form of the target chemical.

### BRIEF DESCRIPTION OF THE DRAWINGS

FIG. 1 shows a flow diagram of a non-limiting system and method for treating water streams, according to one set of embodiments;

FIG. 2 shows a flow diagram of a system including a reverse osmosis system, a reaction and separation system, membrane reactor system, and a collection system according to one set of embodiments;

FIG. 3 shows a system including two reaction and separation R-CAST® systems connected in series along with a downstream membrane reactor system, which can be used to form an ammonium-containing product according to one set of embodiments;

FIG. 4 is a flow diagram showing pretreatment systems that can be combined with a reverse osmosis system, a reaction and separation system, and/or membrane reactor system, according to one set of embodiments;

FIGS. 5A-5C are flow diagrams showing different combinations of systems including a reverse osmosis system, a reaction and separation system, membrane reactor system, and a collection system according to one set of embodiments;

FIG. 6A shows a plot of ammonia/ammonium percent of species as a function of pH of a solution, or relative ammonia/ammonium concentration in the solution as a function of pH of the solution at varying temperatures, according to one set of embodiments;

FIG. 6B shows a plot of the shift of an ammonia/ammonium equilibrium at a fixed temperature, according to one set of embodiments;

FIG. 7 shows a system including a pre-condenser and a second condenser in fluid communication with an R-CAST® reactor and separation system, according to one set of embodiments;

FIG. 8 depicts a non-limiting example of a membrane reactor system, according to one set of embodiments;

FIG. 9 depicts a non-limiting example of a reverse osmosis system, according to one set of embodiments;

FIG. 10 shows a system including ultrafiltration and reverse osmosis systems, according to one set of embodiments;

FIG. 11 shows a system including a Thermal Turbo CAST® reaction and separation system (a mechanical vapor recompression, high temperature system), which can be used to form an ammonium-containing product according to one set of embodiments;

FIG. 12 shows a plot of percent ammonia/ammonium rejection versus percent recovery for a reverse osmosis system, according to one set of embodiments;

FIG. 13 shows a plot of ammonium concentration versus time for the bottoms of an R-CAST® system, according to one set of embodiments; and

FIG. 14 shows a plot of the concentration ratio of ammonia in a vapor:distillate versus the percent condensation for an R-CAST® system comprising a pre-condenser and a second condenser, according to one set of embodiments.

Other aspects, embodiments, and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present description generally relates to methods and systems for treating water streams. In some embodiments, the water stream is wastewater or process water that contains a target chemical (e.g., ammonia and/or ammonium). The methods and systems described herein may include recovering the target chemical from the water stream, and/or producing a desired product (e.g., a fertilizer such as an ammonium salt) from the target chemical. In one set of embodiments, a method of treating a water stream involves introducing the water stream into a system that includes a combination of two or more of, or all of, a reverse osmosis system, a reaction and separation system (e.g., a vacuum distillation system or other suitable separation system), and a membrane reactor system. A variety of system components and configurations are provided and described below.

Improvements and advantages of the system and/or methods described herein as compared to traditional systems and/or methods for recovering a target chemical (e.g., ammonium) and/or producing a product from a water stream may include, for example, reduction or elimination of caustic reagents, heat input energy reduction, capital equipment size/cost reduction, operating cost reduction, and/or carbon dioxide removal and sequestration. Other advantages are provided below.

It should be understood that while much of the discussion herein focuses on water streams comprising wastewater and/or target chemicals comprising ammonium, this is by no means limited, and other types of water streams and/or target chemicals may be used in the methods and systems described herein.

In some embodiments, a method described herein comprises the following steps. A water stream (e.g., a wastewater stream or a process water stream) comprising a target chemical is introduced into a reverse osmosis system, wherein a retentate is formed comprising a de-watered, more concentrated solution of the target chemical. The retentate is passed to a second system, wherein the second system comprises a reaction and separation system adapted and arranged to convert a substantial portion of the target chemical or chemically modified form thereof into a vapor containing the target chemical or chemically modified form thereof. In some embodiments, the second system includes a vaporizer and the retentate from the upstream reverse osmosis system becomes the bottoms in the vaporizer of the second system. At least a portion of the bottoms may be vaporized to form a vapor portion containing a substantial portion of the target chemical and/or chemically modified form thereof. At least some of the vapor portion may be condensed, thereby forming a first liquid containing the target chemical and/or chemically modified form thereof. Prior to vaporizing the bottoms, the method may optionally comprise modifying the conditions of the bottoms, thereby aiding the conversion of the target chemical to a chemically modified form thereof. For example, the conditions which may be modified include the pH, the temperature, the pressure, and/or the addition of one or more additives to the bottoms. Following vaporization and condensation of at least a portion of the vapor portion to form a first liquid, at least a portion of the first liquid is then introduced into a membrane reactor system. The membrane reactor system may comprise a first region and a second region wherein the first and second regions are separated by a membrane, and wherein the second region contains a solution comprises a reagent reactive with the target chemical and/or chemically modified form thereof. In the membrane reactor system, a portion of the target chemical and/or chemically modified form thereof from the first liquid passes through the membrane to the second region, where the target chemical and/or chemically modified form thereof reacts with the reagent to form a desired product. The product may then be further processed, concentrated and/or collected (e.g., using a collection system adapted and arranged to collect the product).

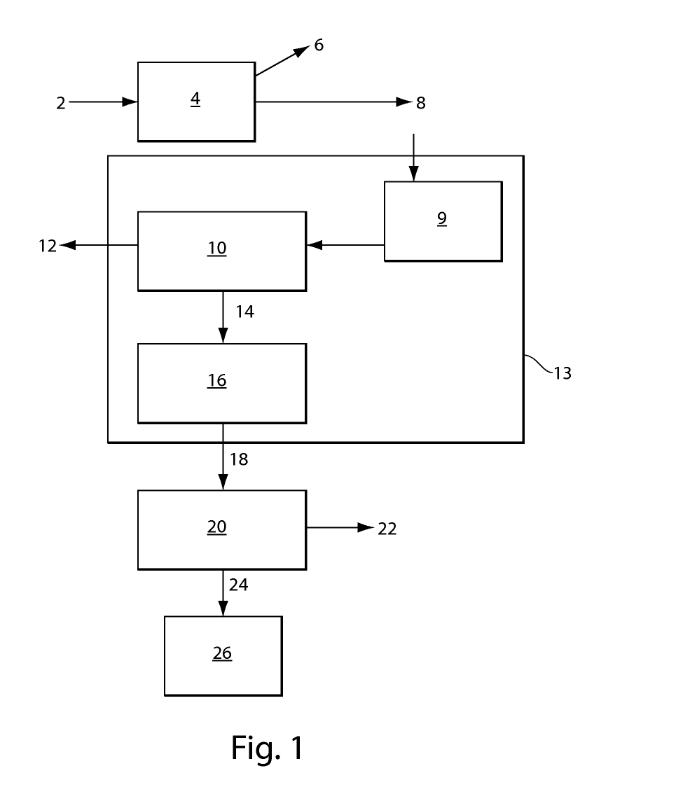

A non-limiting example of a method and a system for treating a water stream is depicted in FIG. 1. In the illustrative embodiment of FIG. 1, the target chemical is ammonium (i.e., [NH₄]⁺), the chemically modified form thereof is ammonia gas (i.e., NH₃ (g)) and/or dissolved ammonia gas (i.e., NH₃ (aq) or NH₄OH (aq)), and the product is an ammonium salt (e.g., (NH₄)₂SO₄). As shown illustratively in FIG. 1, a water stream 2 comprising ammonium is introduced into a reverse osmosis system 4, wherein a permeate 6 (e.g., comprising substantially pure water) and a retentate 8 comprising ammonium are formed. Advantageously, in systems including an upstream reverse osmosis system, a de-watered, more concentrated solution of the target chemical (e.g., retentate 8) may be produced such that less energy and equipment may be used in subsequent processing steps.

Permeate 6 may be further processed and/or disposed of in any suitable manner. Retentate 8 is introduced into a second system 13 and becomes a bottoms portions. In second system 13, the bottoms are exposed to a set of conditions 9 so as to convert a substantial portion of the ammonium to ammonia gas. The conditions 9 to which the bottoms may be exposed to include, for example, changes in the pressure, pH (including the addition of an acid or a base), and/or temperature of the water, as described herein. The solution is then introduced into a vaporizer 10. In vaporizer 10, a vapor portion 14 comprising the ammonia gas is formed, as well as a bottoms 12 (e.g., comprising water). Bottoms 12 may be further processed and/or disposed of in any suitable manner. Vapor portion 14 comprising the ammonia is exposed to a condenser 16, wherein a first liquid 18 is formed containing ammonia gas, dissolved ammonia gas, and/or ammonium solution.

In some embodiments, first liquid 18 is introduced into a first region of a membrane reactor system 20. The membrane reactor system may include, for example, a first region and a second region, wherein the first region and the second region are separated by a membrane. The second region may contain a solution comprising an acid (e.g., sulfuric acid) that may react with a component in the first liquid. In one set of embodiments, for example, membrane reactor system 20 may be a tangential flow hollow fiber filtration system. In one such embodiment, a portion of the dissolved ammonia gas in first liquid 18 passes through the membrane into the second region and reacts with the acid to form the product in a second fluid 24 in the second region, wherein the product is an ammonium salt (e.g., (NH₄)₂SO₄). The remaining fluid from the first region (e.g., a fluid 22) may be further processed and/or disposed of in any suitable manner. A fluid 24 from the second region which contains the product may be further processed and/or collected in any suitable manner. For example, fluid 24 containing the ammonium salt may be collected using a collection system 26. In some cases such as when permeate 6, bottoms 12, and/or fluid 22 from first region still contains a significant amount of ammonia gas, one or more of the solutions may be returned to one of the earlier systems (e.g., the reverse osmosis system, the reaction and separation system) for additional processing.

It should be appreciated that in some embodiments, not all systems, components, or steps need be present in the overall system shown in FIG. 1, and that in other embodiments, other system, components, or steps may be present. For example, as described in more detail below, in certain embodiments, a system includes a reverse osmosis system 4, a second system 13, and a collection system 26, but not a membrane reactor system 20. In other embodiments, a system includes a second system 13, a collection system 26, and a membrane reactor system 20, but not a reverse osmosis system 4. In yet other embodiments, second system 13 may be used to retrieve and/or process a target chemical (or modified form thereof) from a bottoms portion instead of a vapor portion. Other configurations are also possible.

Conditions of the wastewater may be modified so as to facilitate conversion of the target chemical to a chemically modified form thereof, if desired. For example, the wastewater may be optionally heated, one or more additives can be provided to the wastewater stream, and/or the vacuum pressure of the wastewater stream may be increased or decreased, thereby aiding in the conversion of the target chemical to a chemically modified form thereof. For example, in this figure, addition of a base and/or adjustment of the conditions of the wastewater (e.g., pressure, temperature), can shift the ammonium/ammonia equilibrium such that a substantial portion (e.g., substantially all) of the ammonium is in vapor for further processing. Other variations of the system are also described herein. Other specific components and systems, such as those described in the Examples section, can also combined with the systems and methods described herein.

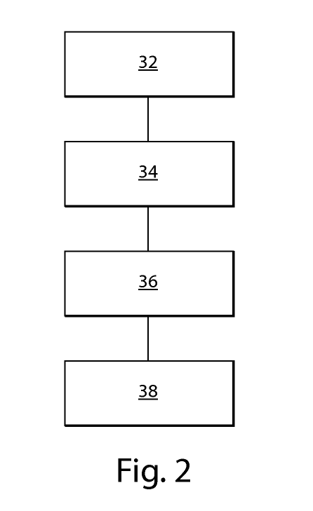

An exemplary overview of a system (e.g., as used in connection with the method shown in FIG. 1) is shown in FIG. 2. In FIG. 2, the system comprises a reverse osmosis system 32, a reaction and separation system 34 in fluid communication with the reverse osmosis system 32, a membrane reactor system 36 in fluid communication with reaction and separation system 34, and a collection system 38 in fluid communication with membrane reactor system 36. Systems or components in fluid communication with one another may be directly connected to one another without any intervening systems or components, or may have one or more intervening systems or components in the fluid path between the two systems or components. Generally, reverse osmosis system 32 is adapted and arranged to concentrate and/or purify a target chemical in wastewater and form a retentate comprising a de-watered, more concentrated solution of the target chemical; reaction and separation system 34 is adapted and arranged to convert a substantial portion of the target chemical and/or chemically modified form thereof into a vapor containing a chemically modified form of the target chemical; membrane reactor system 36 is adapted and arranged to facilitate a reaction between the target chemical and/or a chemically modified form thereof and a reagent to form a desired product; and collection system 38 is adapted and arranged to collect the desired product. Each of the components in this system is described in more detail herein.

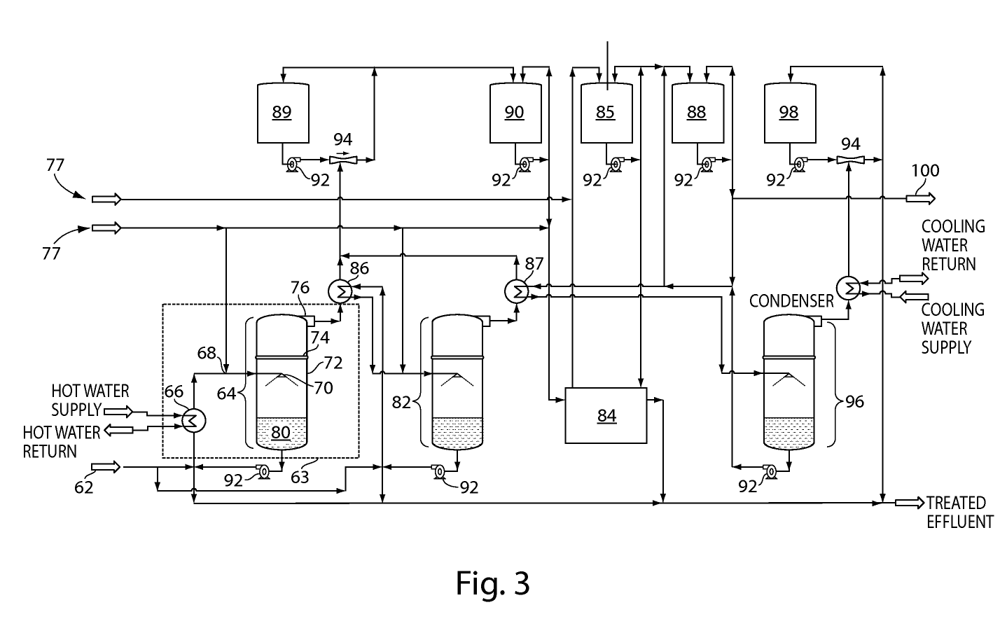

A more detailed process flow diagram of a system encompassed within the system shown in FIG. 2 is provided in FIG. 3, wherein the target chemical exemplified is ammonium. In FIG. 3, wastewater is provided by wastewater feed 62. While it is not depicted, prior to introducing the wastewater to the system depicted in FIG. 3, the water may be optionally processed using a reverse osmosis system or other suitable purification system as described herein. In such embodiments, the wastewater feed 62 introduced into a reaction and separation system may be the retentate produced from the reverse osmosis system or other suitable purification system.

As shown illustratively in FIG. 3, the wastewater is introduced into a reaction and separation system 63. In system 63, the solution containing the ammonia gas (i.e., a chemically modified form of the target chemical, ammonium) may be treated. For example, the wastewater may be heated via heat exchanger 66 and a base (e.g., sodium hydroxide) may be added to the wastewater (e.g., via inlet 68).

In the system shown in FIG. 3, the reaction and separation system comprises a Reverse-Controlled Atmosphere Separation Technology (R-CAST®) system 64, although it should be appreciated that any suitable reaction and separation system can be used. Further description of the R-CAST® system is provided in more detail below. The reaction and separation system functions as follows. The wastewater (e.g., comprising water and ammonia gas) is sprayed via a spray nozzle 70 into a container 72. A portion of the sprayed wastewater is vaporized such that a vapor portion is formed comprising ammonia gas and water vapor. The vapor portion rises and passes through a baffle 74 to condenser a 76, where the vapor is condensed to form a first solution comprising dissolved ammonia gas (i.e., ammonium hydroxide, also known as aqua ammonia). Optionally, in presence of carbon dioxide, ammonium bicarbonate can be formed. In some embodiments, mixtures of ammonium hydroxide and ammonium bicarbonate can be formed. Baffle 74 helps to reduce the amount of water spray droplets that reaches condenser 76.

The portion of wastewater that is not vaporized (e.g., bottoms 80) collects in the bottom of container 72 and is disposed of and/or further processed accordingly. For example, bottoms 80 may be reheated and passed through R-CAST® system 64 again (e.g., to further collect ammonia gas in vapor form and/or reduce the amount of ammonia gas in the bottoms). In some embodiments, two separation and reaction systems may be connected in parallel such that wastewater can be introduced into the two systems for parallel processing. For example, in the system shown in FIG. 3, R-CAST® system 64 and system 82 (e.g., comprising a second spray nozzle, a second container, a second baffle, and a second condenser) are connected in parallel and wastewater can be introduced into each system simultaneously. In some embodiments, the heat recovered from one system may be used for heating all or portions of another system; that is, heat recovery and use may be connected in series. For example, heat recovered from system 64 may be used to heat all or portions of system 82.

In other embodiments, the condensed vapor portion from R-CAST® system 64 may optionally be processed by one or more additional R-CAST® systems connected in series, e.g., such that the output of one system is introduced into another system. In such a system, the bottoms solution from the first R-CAST® system may be introduced into the second R-CAST® system. In serial operation, the target chemical concentration in the feed to the second stage R-CAST® (i.e., ammonia reduced bottoms from the first stage R-CAST®) is typically lower than the concentration of the feed to the first stage R-CAST®. Moreover, the concentration of the target chemical in the condensed vapor portion of the second R-CAST® system positioned in series is typically lower than the concentration of the target chemical in a second R-CAST® positioned in parallel with respect to the first R-CAST® system. Conversely, the concentration of the target chemical in the first R-CAST® condensed vapor portion is typically higher for serial operation as compared with parallel operation, as well as higher than that in the second stage R-CAST® for serial operation. This enables a substantially higher concentration target chemical to be attained and recovered from the first stage R-CAST®. In other embodiments, additional R-CAST® systems (e.g., third, fourth, fifth, etc. systems), positioned in series or parallel with respect to one another, may be included.

The condensed vapor portion from either first R-CAST® system 64 or second R-CAST® system 82 may be introduced into membrane reactor system 84, wherein the membrane reactor system operates as described herein (e.g., a second solution comprising the product is formed in a second region of the membrane reactor system by reacting a reagent with a component of condensed vapor portion). In this exemplary embodiment, the product obtained from the membrane reactor system is ammonium sulfate, wherein the second region of the membrane reactor system 84 comprises a solution comprising a reagent such as sulfuric acid. As described herein, other reaction products can be formed by reacting other acids with a component of the condensed vapor portion.

It should be appreciated that the system shown in FIG. 3 may comprise any suitable number of additional components, including, but not limited to, systems and components for providing a base and/or a reagent (e.g., component 77 for providing sulfuric acid), one or more storage tanks for intermediate solutions (e.g., solutions 85, 88, 89, 90), pump(s) (e.g., pump 92), heater(s), condenser(s) in addition to those associated with the R-CAST® system(s), venturi(s) (e.g., venturi 94), inlets, outlets, collection system(s) for the waste solutions from the membrane reactor system, etc., as known to those of ordinary skill in the art.

Following formation of a solution comprising the product, the product may be further processed and/or collected. In some cases, the solution comprising the product is further processed to increase the concentration of the product in the solution. Alternatively, the solution comprising the product may be collected and used without further processing. Post-processing methods and systems are described herein. As shown in FIG. 3, this exemplary system comprises CAST® system 96 which functions in a similar manner to the R-CAST® system described above, except in the CAST® system, water vapor is removed via the vaporization process and the bottoms contain a more concentrated solution of the desired chemical (e.g., a product such as ammonium sulfate). The product may then be collected (e.g., in a collection tank) and removed from the system (e.g., via outlet 100). Further description of the CAST® system is provided in more detail below.

In some embodiments, the methods and/or systems are configured so as to ensure that the overall systems and/or methods functions in an energy efficient manner. For example, the heating/condensing systems of components of an overall system may be adapted and arranged to operate in connection with each other, so that the heat can be passed and/or conserved from one system to the next. For example, in FIG. 3, the wastewater is heated only once by an external heater (e.g., heater 66), prior to introducing the wastewater to R-CAST® system 64. Heat may be exchanged between the condensate from first R-CAST® system 64 and the solution being introduced to the second R-CAST® system 82 via heat exchanger or condenser 86). Similarly, heat may be exchanged between second R-CAST® system 82 and CAST® system 96 (e.g., via heat exchanger or condenser 87). As will be understood by those of ordinary skill in the art, the operating temperature of each subsequent downstream system will generally be lower compared to an upstream system (i.e., the system to which the downstream system is deriving its heat), and thus, each subsequent downstream system may have a lower absolute pressure or higher vacuum compared to the previous upstream system to compensate for the lower heat. For example, in one embodiment for ammonia recovery, first R-CAST® system 64 is operated at a temperature between 185-195 F and a pressure between about 5-6 inches Hg vacuum, second R-CAST® system 82 is operated at a temperature of about 165 F and at a pressure of between about 10-15 inches Hg vacuum, and CAST® system 96 is operated at a temperature of about 145 F and at a pressure of about 24 inches Hg vacuum. All or portions of heat generated from R-CAST® system 64 may be used to heat R-CAST® system 82, and all or portions of heat generated from R-CAST® system 82 may be used to heat CAST® system 96. Other reaction conditions and configurations are also possible.

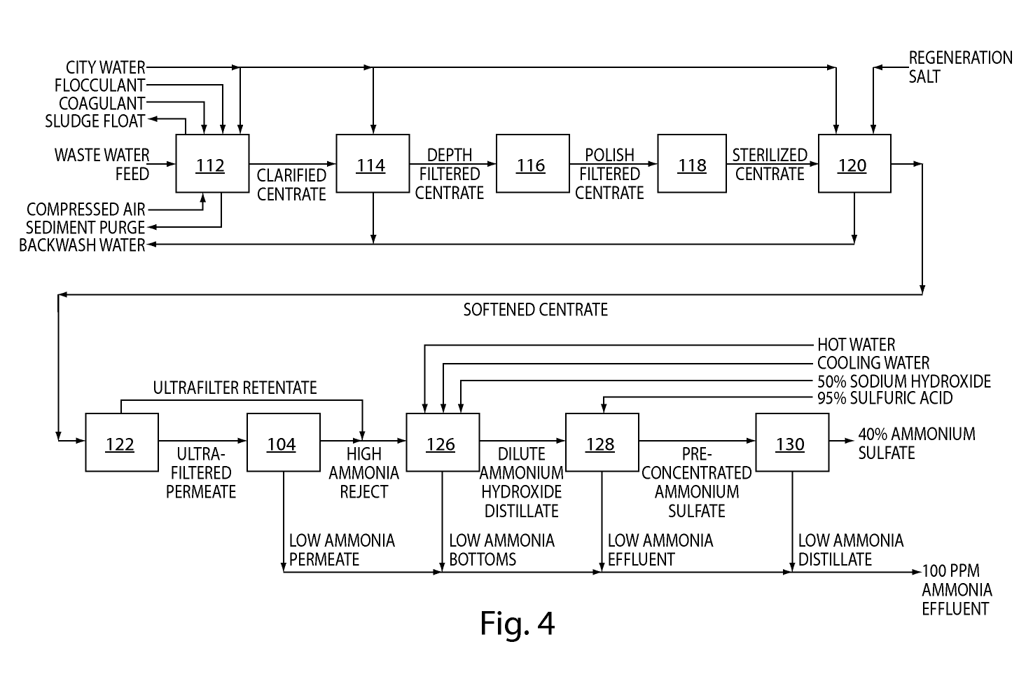

As described herein, the systems and/or methods of the present invention may be used in combination with any other number of system components and/or method steps in order to optimize the performance and/or efficiency of the systems and/or methods. In particular, additional system components and/or method steps will be known to those of ordinary skill in the art for use in combination with wastewater treatment systems and/or methods. Non-limiting examples of additional components include dissolved air flotation systems, multimedia filtration systems, ultraviolet irradiation systems, ion exchange softening systems, ultrafiltration systems, and additional reverse osmosis systems. FIG. 4 shows a non-limiting example of a system including a plurality of pre-process steps/systems prior to introducing the wastewater to reverse osmosis system 104. Additional details of pre-processing systems and/or methods are described herein and in U.S. Pat. No. 7,270,796, which is commonly owned by the assignee of the present application, ThermoEnergy, Inc., and is incorporated herein by reference in its entirety for all purposes.

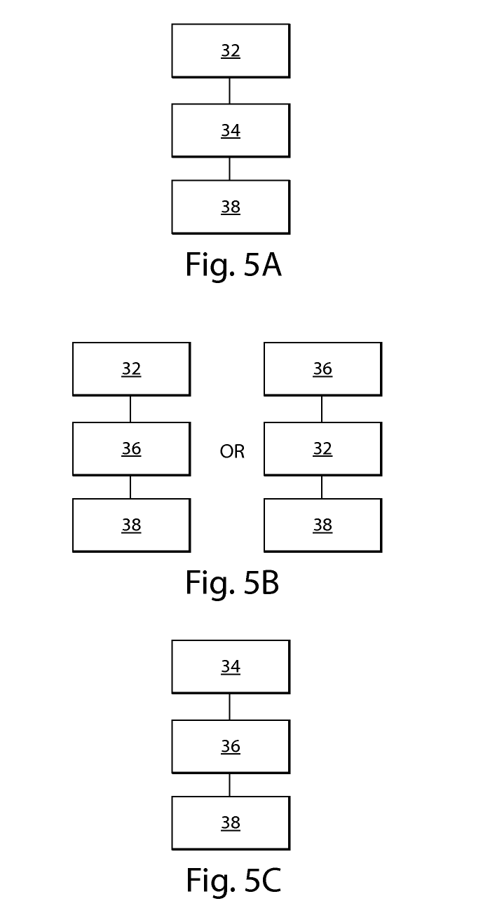

In some embodiments, a system described herein may include a subset of the systems described in FIG. 2. Non-limiting examples of such systems are described in FIG. 5. In one non-limiting embodiment, as shown in FIG. 5A, a system comprises a reverse osmosis system 32, a reaction and separation system 34, and a collection system 38, wherein the reverse osmosis system is in fluid connection with the reaction and separation system, and the reaction and separation system is in fluid connection with the collection system. In a second non-limiting example, as shown in FIG. 5B, the system comprises a reverse osmosis system 32, a membrane reactor system 36, and a collection system 38, wherein the reverse osmosis system and/or the reverse osmosis system is in fluid connection with the membrane reactor system, and the membrane reactor system is in fluid connection with the collection system. In a third non-limiting embodiment, as shown in FIG. 5C, a system comprises a reaction and separation system 34, a membrane reactor system 36, and a collection system 38, wherein the reaction and separation system is in fluid connection with the membrane reactor system, and the membrane reactor system is in fluid connection with the collection system.

Similarly, a method of treating a water stream may comprise a subset of the steps described in FIG. 1. In a first embodiment, wastewater is introduced into a first system (e.g., a reaction and separation system adapted and arranged to convert a substantial portion of the target chemical into a vapor containing chemically modified form of the target chemical) wherein at least a portion of the wastewater is vaporized in the form of a vapor portion. The vapor portion may contain a substantial portion of the target chemical and/or chemically modified form thereof. As described herein, the first system may optionally comprise modifying one or more conditions of the wastewater, thereby aiding in the conversion of the target chemical to a chemically modified form thereof. At least a portion of this vapor portion (e.g., optionally condensed) is introduced into a first region of a membrane reactor system. In some embodiments, the membrane reactor system comprises a first region and a second region, wherein the first and second regions are separated by a membrane, and wherein the second region contains a second liquid solution comprising a reagent reactive with the target chemical and/or chemically modified form thereof. In the membrane reactor system, a portion of the target chemical and/or chemically modified form thereof passes through the membrane to the second region, wherein the target chemical and/or chemically modified form thereof reacts with the reagent to form a desired product in the second region of the membrane reactor system. The product may then be further processed and/or collected (e.g. using a collection system adapted and arranged to collect the product).

In a second embodiment, wastewater comprising a target chemical is introduced into a reverse osmosis system, wherein a retentate is formed comprising a de-watered, more concentrated solution of the target chemical. The retentate may optionally be treated, thereby converting the target chemical in the retentate into a chemically modified form thereof (e.g., by modifying the conditions of the wastewater, thereby aiding in the conversion of the target chemical to a chemically modified form thereof). At least a portion of the solution containing the target chemical or modified form thereof is introduced into a first region of a membrane reactor system. In some embodiments, the membrane reactor system comprises a first region and a second region, wherein the first and second regions are separated by a membrane, and wherein the second region contains a second liquid solution comprises a reagent reactive with the target chemical and/or chemically modified form thereof. As described in more detail below, the membrane may be selected to prevent bulk mixing between the first and second solutions, while allowing transport of a particular species across the membrane. In the membrane reactor system, a portion of the target chemical and/or chemically modified form thereof passes through the membrane to the second region, wherein the target chemical and/or chemically modified form thereof reacts with the reagent to form a desired product in the second region of the membrane reactor system. The product may then be further processed and/or collected (e.g. using a collection system adapted and arranged to collect the product).

In a third embodiment, a wastewater stream comprising a target chemical is introduced into a reverse osmosis system, wherein a retentate is formed comprising a de-watered, more concentrated solution of the target chemical. The solution comprising the target chemical or chemically modified form of the target chemical may be passed to a second system (e.g., a reaction and separation system) wherein at least a portion of the wastewater is vaporized to form of a vapor portion. In some embodiments, the vapor portion contains a substantial portion of the target chemical and/or chemically modified form thereof. Prior to forming the vapor portion, the conditions of forming the solution comprising the target chemical or chemically modified form thereof, or characteristics of the solution itself, may be modified, e.g., by converting a substantially portion of the target chemical in the solution into a chemically modified form thereof. Following formation of the vapor portion, at least a portion of the vapor portion may be condensed, thereby forming a first liquid containing the target chemical and/or chemically modified form thereof. The solution comprising the chemically modified form of the target chemical may be further processed and/or collected (e.g. using a collection system adapted and arranged to collect the product).

Additional details and embodiments with respect to the systems and/or methods described above will now be described in detail, including, but not limiting to reverse osmosis systems and related methods, reaction and separation systems and related methods, membrane reactor systems and related methods, exemplary target chemicals or chemically modified forms thereof, pre-processing systems and related methods, post-processing systems and related methods, collection systems and methods and systems related to the recovery of ammonia from water streams. It will be understood by those of ordinary skill in the art that many of the above-mentioned components, systems, and/or method steps can be modified, removed, or replaced as needed, or other components, systems, and/or method steps can be added for various purposes, without departing from the scope of the invention.

Target Chemicals and/or Chemically Modified Forms thereof

Those of ordinary skill in the art will be aware of suitable target chemicals that may be used and/or recovered with the systems and/or methods described herein. Generally, the target chemical is a chemical which is present in wastewater and/or process water, where it is desired to remove and/or recover the target chemical from the wastewater and/or process water. In some embodiments, the removal and/or recovery of the target chemical may be desired so that the target chemical can be recovered from the wastewater and/or process water in order to be used in another application. Additionally or alternatively, removal of the target chemical may be necessary to allow for reuse and/or disposal of the wastewater and/or process water in an appropriate fashion (e.g., treating municipal wastewater according to state standards).

In some embodiments, the methods and/or systems described herein are employed to recover a target chemical, wherein the target chemical may be converted into a chemically modified form thereof at some point during the method and/or by one or more components of the system. A chemically modified form of a target chemical may include a chemical which has the same (or a similar) underlying structure (e.g., bonding, main elements, etc.) but has been chemically modified in some manner, such as by addition or removal of a positive or negative charge and/or addition or removal of an atom or a group of atoms, etc. For example, ammonia (NH₃) is a chemically modified form of ammonium (NH₄⁺), and vice versa. In some embodiments, in addition to a chemical change, a physical change between a target chemical and a chemically modified form a target chemical can also take place, such as a change of phase between a liquid and a gas, a change in solubility, etc.

Reaction conditions to perform a desired reaction will be discernible to those of ordinary skill in the art, given the knowledge of those skilled in the art supplemented and informed by the description provided herein. In some embodiments, the chemically modified form of the target chemical can be optionally converted back to the target chemical in one or more process steps described herein.

In some embodiments, a target chemical has a first phase or state, and the chemically modified form thereof has a second, different phase or state. For example, in some cases, the target chemical is a dissolved solute, and the chemically modified form thereof is a gas or a dissolved gas. As another example, the target chemical is a dissolved solute, and the chemically modified form thereof is a precipitate. In some cases, the chemically modified form of the target chemical is a conjugated base or acid of the target chemical.

Any suitable concentration of a target chemical may be present in a water stream to be treated (e.g., wastewater or process water). For example, in some embodiments, the concentration of a target chemical, prior to being introduced into a system described herein, may be greater than or equal to about 5 ppm (by weight), greater than or equal to about 50 ppm, greater than or equal to about 100 ppm, greater than or equal to about 200 ppm, greater than or equal to about 500 ppm, greater than or equal to about 1000 ppm, greater than or equal to about 2000 ppm, greater than or equal to about 5000 ppm, greater than or equal to about 10000 ppm, greater than or equal to about 20000 ppm, greater than or equal to about 30000 ppm, greater than or equal to about 40000 ppm, greater than or equal to about 50000 ppm, greater than or equal to about 75000 ppm, or greater than or equal to about 100000 ppm. In some embodiments, the concentration of a target chemical, prior to being introduced into a system described herein, may be less than about 150000 ppm (by weight), less than about 100000 ppm, less than about 75000 ppm, less than about 50000 ppm, less than about 30000 ppm, less than about 20000 ppm, less than about 10000 ppm, less than about 5000 ppm, less than about 2000 ppm, less than about 1000 ppm, less than about 500 ppm, less than about 100 ppm, less than about 50 ppm, or less than about 10 ppm. Combinations of the above-referenced ranges are also possible (e.g., a concentration of greater than equal to about 5 ppm and less than about 5000 ppm). Other ranges are also possible.

In some embodiments, the target chemical is converted into a chemically modified form thereof by modifying one or more conditions of the environment about the chemical. Non-limiting examples of conditions which may affect the conversion of a target chemical into a chemically modified form thereof include pH, temperature, pressure, presence or absence of additives or reactants, etc. In some embodiments, the conditions which may be varied is the pH of the environment of the target chemical, wherein an increase or decrease of the pH results in the target chemical being converted into a chemically modified form thereof. In another embodiment, the condition which is varied is the temperature of the environment of the target chemical, wherein an increase or decrease of the temperature results in the target chemical being converted into a chemically modified form thereof. Those of ordinary skill in the art will be aware of suitable changes in conditions for converting a target chemical into a chemically modified form thereof. As a non-limiting example, at a first pH, the target chemical may be a dissolved solute in the water, and at a second, different pH, the target chemical may be converted into a chemically modified form thereof, wherein the chemically modified form thereof is a gas or a dissolved gas.

In some embodiments, the target chemical is ammonium and the chemically modified form thereof is ammonia gas or dissolved ammonia gas (e.g., as ammonium hydroxide). The ammonium may be associated with various different counter ions, for example, carbonate. The ammonium may be a solute in an aqueous solution and an increase in the pH (for example, by addition of a base (e.g., sodium hydroxide)) and/or an increase in the temperature may cause the conversion of ammonium to ammonia gas as shown in Equation 1. As will be known to ordinary skill in the art, in some embodiments, the ammonia gas in water may be present in the form of ammonium hydroxide, for example, as shown in Equation 2. Accordingly in some embodiments, the target chemical is ammonium and the chemically modified form thereof is ammonia gas or dissolved ammonia gas (e.g., as ammonium hydroxide).

[NH₄]⁺ (aq)+OH⁻ (aq) [symbol] NH₃ (g)+H₂O (1)

NH₃ (g)+H₂O [symbol] NH₄OH (aq) (2)

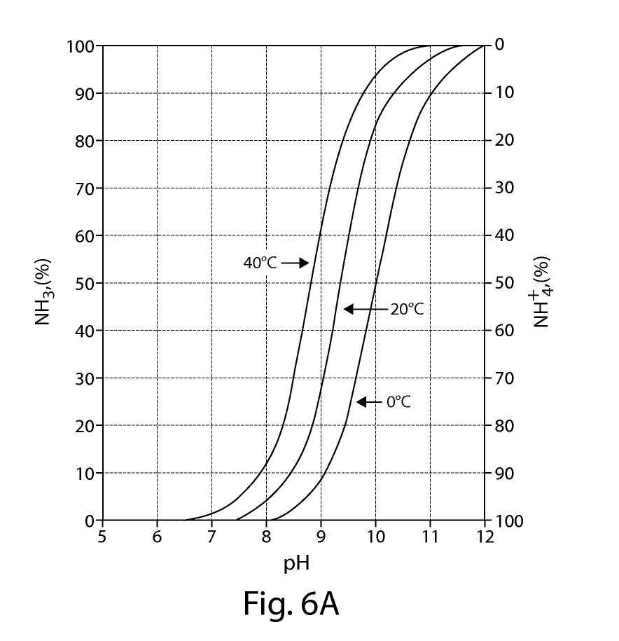

Methods and conditions for shifting the ammonia/ammonium equilibrium will be known to those of ordinary skill in the art. Generally, as the temperature and/or pH is increased (e.g., via addition of a base such as sodium hydroxide, lime, potassium hydroxide, etc.), the equilibrium shifts towards the presence of ammonia. FIG. 6A shows a plot of ammonia/ammonium percent of species as a function of pH of a solution, or relative ammonia/ammonium concentration in the solution as a function of pH of the solution. FIG. 6B illustrates the equilibrium shift at varying pH at a fixed temperature. Ammonia/ammonium systems and conditions for shifting the equilibrium are described in more detail herein.

In some embodiments, a target chemical or chemically modified form thereof is exposed to a reagent (e.g., a reagent contained in a tank in fluid communication with a reaction and separation system, such as a dilute ammonium hydroxide tank), and the target chemical or chemically modified form thereof reacts with the reagent to form a desired product. Those of ordinary skill in the art will be aware of suitable reagents to employ in a system and/or method, depending on the nature of the target chemical or chemically modified form thereof, to form a desired product. In some cases, the reagent may react with the target chemical or chemically modified form thereof to form the product, wherein the product has a different phase and/or state as compared to the target chemical or chemically modified form thereof. For example, in some embodiments, the chemically modified form of the target chemical is a gas or a dissolved gas, and the desired product is a dissolved solute. As another example, in some embodiments, the chemically modified form of the target chemical is a gas or a dissolved gas, and the desired product is a precipitate.

In embodiments where the target chemical is ammonium and the chemically modified form thereof is ammonia gas or dissolved ammonia gas, the reagent may be an acid, and the desired product may be an ammonium salt. Those of ordinary skill in the art will be aware of suitable acid reagents which are reactive with ammonia gas to form an ammonium salt. In some embodiments, the acid may be an organic or an inorganic acid. Non-limiting examples of acids include sulfuric acid, phosphoric acid, citric acid, nitric acid, hydrochloric acid, acetic acid, formic acid, and the like. In one embodiment, the acid is sulfuric acid and the product is ammonium sulfate. In another embodiment, the acid is nitric acid and the product is ammonium nitrate. Other ammonium salts can also be formed including, for example, ammonium carbonate and ammonium bicarbonate. In some cases, ammonium salts can be obtained by reaction of an ammonium salt with a base (e.g., the reaction of ammonium chloride and/or ammonium sulfate with a carbonate source such as calcium carbonate to form ammonium carbonate). Ammonium salts may be soluble in water, or may form precipitates in water. Other reactions with ammonium-containing salts are also possible to form other ammonium-containing products.

In certain embodiments, the systems and methods described herein may be used to capture a target chemical (or chemically modified form thereof) that changes to and from a gaseous state with a change in pH. In certain embodiments, carbon dioxide may be captured by reacting to form ammonium bicarbonate, and the ammonium carbonate may be captured by increasing the pH of the system. In some such embodiments, the wastewater or process water may first be acidified to form and release carbon dioxide and then captured in sodium hydroxide in a separation and reaction system. In another embodiment. the wastewater or process water is acidified to form hydrogen sulfide and then captured in sodium hydroxide as sodium sulfide.

In some embodiments, low molecular weight organic acid such formic acid and acetic acid may be target chemicals. They may be acidified and captured as, for example, sodium formate/acetate. The capturing liquid may be water, an acid or a base. In other embodiments, gaseous hydrogen sulfide and hydrogen cyanide can be captured in caustic respectively as sodium sulfide and sodium cyanide. Low molecular, non-ionic organics (e.g., methanol) that are soluble and recoverable in water could also be captured/removed using the methods and systems described herein.

Methods and Systems Related to Recovery of Ammonia and/or other Chemicals from Water Streams

In some embodiments, the methods and/or systems described herein may be used for recovering ammonium from a water stream and/or for producing an ammonium product from a water stream.

In some embodiments, a method for recovering ammonia from water (e.g., wastewater or process water) is as follows. A water stream comprising ammonium is provided. The temperature of the water is increased and/or the pH of water is adjusted, thereby shifting the ammonium/ammonia equilibrium towards the formation of ammonia gas and converting a substantial portion of the ammonium to ammonia gas or dissolved ammonia gas. The water containing the converted ammonia gas is introduced into vaporizer, which may be optionally operated at a pressure lower than atmospheric pressure to form a vapor portion of the water, wherein the vapor portion contains a substantial portion of the ammonia gas. The vapor portion may be collected, thereby recovering ammonia from the water.

In some cases, the systems/methods described herein (such as a separation and reaction system) are operated at higher temperatures as compared to previous systems for ammonium recovery, such that the higher temperatures allow for the system to be operated at a less basic (more acidic) pH. Advantageously, operating the system at a less basic pH may involve the use of relatively lower amounts of caustic materials (and thereby making the operation more economically feasible) than operations at lower temperatures.

In some cases, the water comprising the ammonium (e.g., in a separation and reaction system and/or during conversion of ammonium to ammonia gas) has a temperature of at least about 150 F, at least about 160 F, at least about 170 F, at least about 180 F, at least about 190 F, at least about 200 F, or greater (e.g., in a separation and reaction system and/or during conversion of ammonium to ammonia gas). In some cases, the water comprising the ammonium has a temperature of less than or equal to about 212 F, less than or equal to about 210 F, less than or equal to about 200 F, less than or equal to about 190 F, less than or equal to about 180 F, less than or equal to about 170 F, or less than or equal to about 160 F (e.g., in a separation and reaction system and/or during conversion of ammonium to ammonia gas). Combinations of the above-referenced ranges are also possible (e.g., a temperature of at least about 160 F and less than or equal to about 200 F). Other ranges are also possible.

In some cases the temperature of the water is increased to between about 160 F and about 200 F, or between about 170 F and about 200 F, or between about 180 F and about 200 F, or between about 190 F and about 200 F, or between about 160 F and about 190 F, or between about 160 F about 180 F, or between about 160 F and about 170 F, or between about 170 F and about 190 F, or between about 170 F and about 180 F, or between about 180 F and about 190 F, or any suitable range therein.

In some cases the pH of the water comprising the ammonium (e.g., in a separation and reaction system and/or during conversion of ammonium to ammonia gas) is adjusted to be at least about 7.0, at least about 7.5, at least about 8.0, at least about 8.5, at least about 9.0, at least about 9.5, at least about 10.0, at least about 10.5, at least about 11.0, at least about 11.5, or at least about 12.0. In some cases the pH of the water comprising the ammonium is adjusted to be less than or equal to about 12.0, less than or equal to about 11.5, less than or equal to about 11.0, less than or equal to about 10.5, less than or equal to about 10.0, less than or equal to about 9.5, less than or equal to about 9.0, less than or equal to about 8.5, less than or equal to about 8.0, or less than or equal to about 7.5. Combinations of the above-referenced ranges are also possible (e.g., a pH of at least about 7.5 and less than or equal to about 11.0). Other ranges are also possible.

In some cases, the vaporizer of a separation and reaction system (e.g., during conversion of ammonium to ammonia gas) is operated at a pressure between about 1 and about 25 inches Hg vacuum, between about 1 and about 21 inches Hg vacuum, between about 5 and about 21 inches Hg vacuum, between about 6 and about 21 inches Hg vacuum, between about 10 and about 21 inches Hg vacuum, between about 6 and about 15 inches Hg vacuum, between about 0 and about 29.9 inches Hg vacuum, between about 5 and about 29.9 inches Hg vacuum, or any suitable range therein. In some cases, the pressure is at least about 1 inches Hg vacuum, at least about 2 inches Hg vacuum, at least about 5 inches Hg vacuum, at least about 6 inches Hg vacuum, at least about 10 inches Hg vacuum, at least about 15 inches Hg vacuum, or at least about 20 inches Hg vacuum. In some embodiments, the pressure is less than or equal to about 29.9 inches Hg vacuum, less than or equal to about 21 inches Hg vacuum, less than or equal to about 15 inches Hg vacuum, or less than or equal to about 10 inches Hg vacuum. Combinations of the above-referenced ranges are also possible. Other ranges are also possible.

The vapor portion comprising the ammonia gas (and/or other target chemical and/or chemically modified form thereof) may be collected in any suitable manner (e.g., after being processed in a reaction and separation system), as will be known to those of ordinary skill in the art. The ammonia gas (and/or other target chemical and/or chemically modified form thereof) may be collected in gaseous form, liquid form, or in combinations thereof. In some cases, the ammonia gas (and/or other target chemical and/or chemically modified form thereof) may be reacted with a suitable base, or with suitable acid to form the collected product.

In some embodiments, the vapor portion comprising the ammonia may be condensed (e.g., using a condenser) into a liquid (i.e., a condensate). In embodiments in which the vapor portion to be condensed also comprises some water vapor, the condensate may be in the form of an ammonia solution in which the ammonia gas is dissolved in water in the form of ammonium hydroxide and/or ammonium bicarbonate in presence of carbon dioxide. Alternatively, the vapor portion may be sprayed and/or contacted with an acidic solution, thereby forming a solution comprising an ammonium salt. Such systems for contacting the ammonia gas with an acid are described in the art, for example, see U.S. Pat. No. 7,270,796, which is commonly owned by the assignee of the present application, ThermoEnergy, Inc., and is incorporated herein by reference in its entirety for all purposes. The solution comprising the ammonium salt solution may be collected and/or further processed (e.g., by introducing the ammonium salt solution to a reverse osmosis and/or a CAST® system), thereby further concentrating the ammonium salt in the solution.

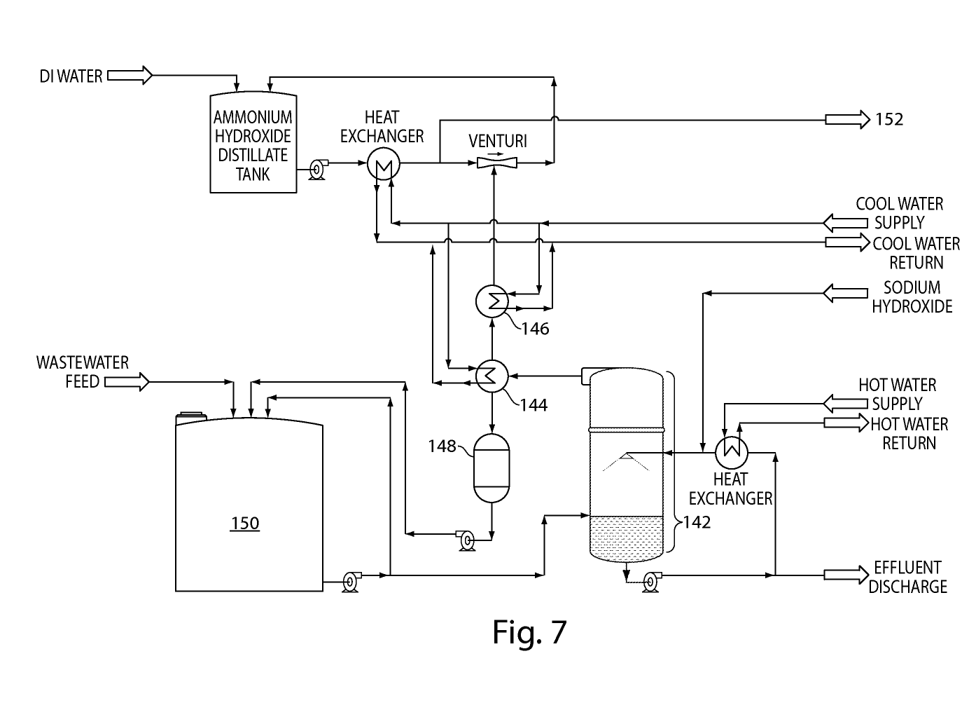

In some embodiments, the methods and/or systems described herein allow for the production of a solution comprising an ammonium salt at a relatively high concentration, without the need for costly and/or energy-intensive concentration and/or purification steps. The resulting solution may be at a concentration so that no additional process steps (e.g., a downstream distillation step) are necessary before use of the solution in other applications, for example, as a fertilizer. For example, in some embodiments, a method for producing ammonium product from a water stream comprises the following (e.g., continuous) steps. A water stream comprising ammonium is provided. A substantial portion of the ammonium in the solution is converted to ammonia gas or dissolved ammonia gas (e.g., as described herein). The solution comprising the ammonia gas is contacted with a second solution comprising an acid (e.g., via a membrane reactor system), wherein the ammonia forms and ammonium acid solution. In some embodiments, the concentration of ammonium acid in the solution, e.g., immediately following the contacting step (e.g., via a membrane reactor system), is greater than or equal to about 20 wt %, greater than or equal to about 25 wt %, greater than or equal to about 30 wt %, greater than or equal to about 35 wt %, greater than or equal to about 40 wt %, greater than or equal to about 45 wt %, or greater than or equal to about 50 wt %. In some embodiments, the concentration of ammonium acid in the solution, e.g., immediately following the contacting step, is less than about 80 wt %, less than about 70 wt %, less than about 60 wt %, less than about 50 wt %, less than about 40 wt %, or less than about 30 wt %. Combinations of the above-referenced ranges are also possible (e.g., a concentration of greater than or equal to about 40 wt % and less than about 80 wt %). Other ranges are also possible. In some embodiments, such ranges of concentrations of the ammonium acid are present in a resulting solution after a water stream comprising an ammonium-containing target chemical has been processed through one of the systems described in FIGS. 1, 2, 3, 4, 5A, 5B, or 5C. In some cases, such ranges of concentrations of the ammonium acid are present in a resulting solution in a downstream membrane reactor system (e.g., membrane reactor system 20 or 36), such as in a second region 174 of the membrane reactor system shown in FIG. 8, or in a collection system immediately downstream of the membrane reactor system. In some such embodiments in which relatively high concentrations of the desired product are produced in the reactor system, a downstream distillation step to concentrate the resulting solution is not needed.

In some embodiments, the acid used to react with a target chemical and/or a chemically modified form thereof, or the acid in the second solution, is sulfuric acid, and the resulting product is an ammonium salt (e.g., ammonium sulfate). Those of ordinary skill in the art will be aware of methods and systems for contacting the solution comprising the dissolved ammonia gas with an acid solution, for example, using a membrane reactor system (e.g., a tangential flow hollow fiber filtration system) as described herein. Other systems that may be used to concentrate the solution collected from the reaction and separation system include a reverse osmosis system and/or an electrodialysis system. These systems could, for example, concentrate the distillate from an R-CAST® system if captured in acid such as ammonium sulfate. The ammonium salt solution may or may not be further processed and/or collected using systems and methods known to those of ordinary skill in the art and/or as described herein.

In some embodiments, the methods and system described herein also allow for the sequestration of carbon dioxide formed via the decomposition of ammonium bicarbonate. In some embodiments, a water stream may be rich in bicarbonate, and therefore, a portion of the ammonium may be present as a bicarbonate salt. As will be known to those of ordinary skill in the art, generally the amount of base required for addition to the system in order to convert a substantial portion of the ammonium to ammonia gas will depend on the concentration of bicarbonate in the wastewater, according to the reactions outlined in Equations 3 and 4. Accordingly, if the amount of bicarbonate in the water is significant, a greater amount of base is generally required to convert the ammonium bicarbonate to ammonia gas. However, if relatively high temperatures are employed, instead of converting the ammonium bicarbonate to ammonia gas via an acid/base reaction, the ammonium bicarbonate can instead be decomposed to form ammonia gas, carbon dioxide, and water vapor, as outlined in the reaction shown in Equation 5. By employing decomposition instead of acid/base chemistry to convert the ammonium bicarbonate to ammonia gas, the amount of base required can be reduced (e.g., thereby making the operation more economically feasible and/or environmentally friendly); furthermore, the carbon dioxide formed can be sequestered using known systems and methods.

NaHCO₃+NaOH→Na₂CO₃+H₂O (3)

NH₄HCO₃+2NaOH→Na₂CO₃+NH₃+2H₂O (4)

NH₄HCO₃→NH₃+CO₂+H₂O (5)

In embodiments in which a target chemical in a water stream is processed (e.g., converted into a chemically modified form thereof) and/or removed from the water stream, the concentration of the target chemical may be reduced after a processing step (e.g., after being passed through a reaction and separation system, membrane reactor system and/or collection system) compared to the initial concentration of the target chemical in the water stream. In other embodiments, the concentration of the target chemical may be increased in a processing step (e.g., after being passed through a reverse osmosis system) compared to the initial concentration of the target chemical in the water stream. After passing through one or more of these (or other) processing steps, the concentration of the target chemical may be, for example, less than about 150000 ppm (by weight), less than about 100000 ppm, less than about 75000 ppm, less than about 50000 ppm, less than about 30000 ppm, less than about 20000 ppm, less than about 10000 ppm, less than about 5000 ppm, less than about 2000 ppm, less than about 1000 ppm, less than about 500 ppm, less than about 100 ppm, less than about 50 ppm, or less than about 10 ppm. In some embodiments, the concentration of the target chemical after passing through one or more of these (or other) processing steps may be greater than or equal to about 5 ppm (by weight), greater than or equal to about 50 ppm, greater than or equal to about 100 ppm, greater than or equal to about 200 ppm, greater than or equal to about 500 ppm, greater than or equal to about 1000 ppm, greater than or equal to about 2000 ppm, greater than or equal to about 5000 ppm, greater than or equal to about 10000 ppm, greater than or equal to about 20000 ppm, greater than or equal to about 30000 ppm, greater than or equal to about 40000 ppm, or greater than or equal to about 50000 ppm. Combinations of the above-referenced ranges are also possible (e.g., a concentration of less than equal to about 5000 ppm and greater than or equal to about 5 ppm). Other ranges are also possible. In some embodiments, the concentration of the target chemical may have one or more of the above-referenced ranges in, for example, first liquid 18, second fluid 24, and/or in collection system 26 of FIG. 1 (e.g., after being processed through an evaporator, a crystallizer, or a dryer, etc.).

In some embodiments, a concentration of a target chemical in a water stream is reduced after a processing step (e.g., after being passed through a reaction and separation system, membrane reactor system and/or collection system) by at least 2 times, at least 5 times, at least 10 times, at least 25 times, at least 50 times, at least 75 times, at least 100 times, at least 150 times, at least 200 times, at least 300 times, at least 500 times, at least 700 times, or at least 1000 times compared to the initial concentration of the target chemical in the water stream. In other embodiments, a concentration of a target chemical in a water stream is increased after a processing step (e.g., after being passed through a reverse osmosis system) by at least at least 2 times, at least 5 times, at least 10 times, at least 25 times, at least 50 times, at least 75 times, at least 100 times, at least 150 times, at least 200 times, at least 300 times, at least 500 times, at least 700 times, or at least 1000 times compared to the initial concentration of the target chemical in the water stream. Other ranges are also possible.

Similarly, in embodiments in which a target chemical in a water stream is processed and eventually converted into a desired product (e.g., a chemically modified form of a target chemical). The desired product (or chemically modified form of the target chemical) may have any suitable concentration. For example, in some embodiments, the concentration of a desired product (or chemically modified form of a target chemical) may be greater than or equal to about 5 ppm, greater than or equal to about 50 ppm, greater than or equal to about 100 ppm, greater than or equal to about 200 ppm, greater than or equal to about 500 ppm, greater than or equal to about 1000 ppm, greater than or equal to about 2000 ppm, greater than or equal to about 5000 ppm, greater than or equal to about 10000 ppm, greater than or equal to about 20000 ppm, greater than or equal to about 30000 ppm, greater than or equal to about 40000 ppm, greater than or equal to about 50000 ppm, greater than or equal to about 75000 ppm, or greater than or equal to about 100000 ppm. In some embodiments, the concentration of a desired product (or chemically modified form of a target chemical) may be less than about 150000 ppm, less than about 100000 ppm, less than about 75000 ppm, less than about 50000 ppm, less than about 30000 ppm, less than about 20000 ppm, less than about 10000 ppm, less than about 5000 ppm, less than about 2000 ppm, less than about 1000 ppm, less than about 500 ppm, or less than about 100 ppm. Combinations of the above-referenced ranges are also possible (e.g., a concentration of greater than equal to about 10000 ppm and less than about 50000 ppm). Other ranges are also possible. In some embodiments, the concentration of the desired product (or chemically modified form of the target chemical) may have one or more of the above-referenced ranges in, for example, a membrane system described herein and/or a collection system described herein. In certain embodiments, such ranges exist immediately after a water stream containing the chemical has passed through a reverse osmosis system, a reaction and separation system, and/or a membrane reactor system. In other embodiments, such ranges exist immediately after a water stream containing the chemical has passed through an evaporator, a crystallizer, or a dryer.

In some embodiments, the concentration of the desired product (e.g., a chemically modified form of a target chemical) may be expressed as a certain range of wt % of the solution the product is contained in. The concentration of the desired product (or chemically modified form of a target chemical) may be, for example, greater than or equal to about 5 wt %, greater than or equal to about 10 wt %, greater than or equal to about 15 wt %, greater than or equal to about 20 wt %, greater than or equal to about 25 wt %, greater than or equal to about 30 wt %, greater than or equal to about 35 wt %, greater than or equal to about 40 wt %, greater than or equal to about 45 wt %, or greater than or equal to about 50 wt %, greater than or equal to about 60 wt %, greater than or equal to about 70 wt %, greater than or equal to about 80 wt %, or greater than or equal to about 90 wt %. In some embodiments, the concentration of the desired product (or chemically modified form of a target chemical) is less than about 100 wt %, less than about 90 wt %, less than about 80 wt %, less than about 70 wt %, less than about 60 wt %, less than about 50 wt %, less than about 40 wt %, or less than about 30 wt %. Combinations of the above-referenced ranges are also possible (e.g., a concentration of greater than or equal to about 40 wt % and less than about 80 wt %). Other ranges are also possible. In some embodiments, the concentration of the desired product (or chemically modified form of the target chemical) may have one or more of the above-referenced ranges in, for example, a membrane system described herein and/or a collection system described herein. In certain embodiments, such ranges exist immediately after a water stream containing the chemical has passed through a reverse osmosis system, a reaction and separation system, and/or a membrane reactor system.

### Reaction and Separation Systems and Related Methods

In some embodiments, a system or method of the present invention may comprise or make use of a reaction and separation system. As described above, a reaction and separation system is generally adapted and arranged to separate a water stream into a vapor portion and a bottoms portion and/or to convert a substantial portion of a target chemical into a chemically modified form of the target chemical.

Suitable unit operations and design parameters and operating conditions for configuring reaction and separation systems to perform a desired reaction/separation according to the invention will be discernible to those of ordinary skill in the art, given the knowledge of those skilled in the art supplemented and informed by the description provided herein of the present inventions. In some embodiments, a reaction and separation system comprises a component (e.g., a vaporizer) which allows for at least a portion of a water stream to be vaporized, thereby forming a vapor portion and a non-vapor portion, e.g., the bottoms. In some such embodiments, a reaction and separation system comprises a vacuum assisted flash evaporation system (e.g., a R-CAST® or CAST® system). The target chemical and/or chemically modified form thereof may be contained in either the vapor portion or the bottoms portion. Whether the vapor portion or the bottoms portion contains the target chemical or chemically modified form thereof will depend on the conditions of the system/method and/or the properties of the target chemical or chemically modified form thereof.

In one set of embodiments, the reaction and separation system comprises an R-CAST® system. An R-CAST® system is a proprietary flash distillation unit operation (e.g., R-CAST®, commercially available from ThermoEnergy, Inc., Worcester, Mass.). The R-CAST® system is generally adapted for separating a water stream into a vapor portion and a bottoms portion, and collecting the vapor or gas which contains a target chemical and/or a chemically modified form thereof. R-CAST® systems are described in more detail in U.S. Pat. No. 7,270,796, issued Sep. 18, 2007, entitled Ammonium/Ammonia Removal from a Stream and having the inventors Kemp et al., and U.S. Patent Publication No. 2007/0297953 A1, published Dec. 27, 2007, entitled Ammonium/Ammonia Removal from a Stream and having the inventors Kemp et al., each of which is commonly owned by the assignee of the present application and is incorporated herein by reference in its entirety for all purposes.

Before, during or after the separation process, the target chemical may optionally be reacted with a reagent to form a chemically modified form of the target chemical. A method of using an R-CAST® system may involve, for example, vaporizing at least a portion of a water stream comprising ammonia gas (or another target chemical or chemically modified form thereof) to form a vapor portion comprising the ammonia gas (or another target chemical or chemically modified form thereof), and collecting the vapor portion comprising the ammonia gas. The R-CAST® system may comprise a number of components and/or may be configured to allow for recovery of latent heat of the distillate and/or so to increase the overall energy efficiency of the system. As described herein, in some embodiments, the conditions of the wastewater may be modified so as to shift the ammonia/ammonium equilibrium to favor the formation of ammonia gas.

In some embodiments, the vapor portion comprising the ammonia gas (or another target chemical or chemically modified form thereof) is produced in an R-CAST® system by spraying the water stream into a R-CAST® container using a spray nozzle. As the water is sprayed from the spray nozzle, a vapor portion forms which comprises the ammonia gas (or another target chemical or chemically modified form thereof) and some water vapor. The vapor portion may be drawn (e.g., via vacuum) through a baffle situated in the upper portion of the R-CAST® container, and the ammonia gas can then be collected. The baffle aids in reducing the amount of water spray droplets in the vapor portion. The liquid portion of the sprayed water is collected in the bottom of the container, and can be further processed and/or disposed of accordingly.

Baffles and other components suitable for use in an R-CAST® system will be known to those of ordinary skill in the art, and have been described previously. See, for example, U.S. Pat. Nos. 4,770,748 and 4,880,504.

The ammonia gas may be drawn through the baffle for collection using any suitable known methods and/or systems. In some embodiments, the ammonia gas is drawn through the baffle using a venturi and/or vacuum pump that creates a vacuum on the container. The vacuum may be provided at a pressure such that substantially all or a substantial portion of the ammonia gas is withdrawn from the container.

As described herein, the ammonia gas may be collected using a variety of methods and systems, as will be known to those of ordinary skill in the art. In some embodiments, the ammonia gas is exposed to a solution comprising an acid, wherein the ammonia gas is converted to an ammonium salt.

In some embodiments, wherein the ammonia gas (or another target chemical or chemically modified form thereof) will be later introduced into a membrane reactor system, the ammonia gas may be collected as a solution comprising the dissolved ammonia gas. In some cases, the ammonia gas is collected by exposing the ammonia-containing vapor to a condenser, thereby forming a liquid portion comprising the dissolved ammonia gas (e.g., optionally present as ammonium hydroxide). In such a system, one or more condensers (e.g., a partial and a total condenser) may be used, as described herein. The one or more condenser may be coupled with another R-CAST® or another downstream system (e.g., in series), optionally whereby heat exchange can occur, thus reducing the overall energy consumption required by the entire system. Systems connected in parallel are also possible. The systems may be operated in a continuous fashion, semi-continuous fashion, batch fashion, etc.

In some embodiments, a system and/or method may make use of more than one condenser, wherein the first condenser is a pre-condenser, and the second condenser is a total condenser. The first condenser may be adapted and arranged so that the portion of the vapor phase comprising the water vapor condenses (e.g., to reduce the amount of water vapor in the vapor portion), and a second condenser may be adapted and arranged to condense the remainder of the vapor portion (e.g., comprising a substantial portion of the target chemical). In some cases, the pre-condenser is adapted and arranged to condense the water vapor in the vapor stream so that the liquid solution formed by contacting the vapor stream with the condenser contains a greater amount of target chemical and/or chemically modified form thereof as compared to a system or method which does not comprise the pre-condenser. That is, use of a pre-condenser in combination with a total condenser may result in the condensate of the vapor phase having a higher concentration of ammonia (or other target chemical or chemically modified form thereof) as compared to a system which does not make use of a pre-condenser.

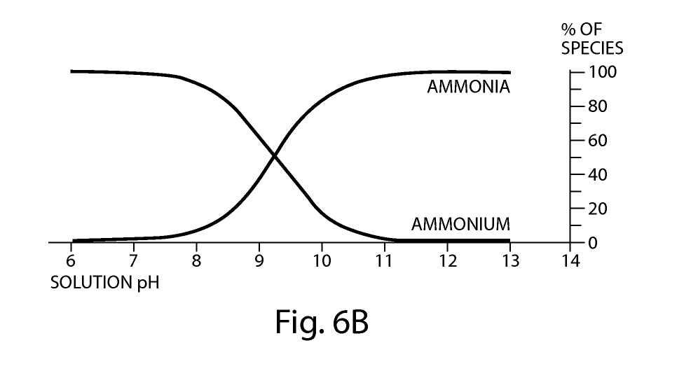

FIG. 7 shows a limiting example of a system comprising an R-CAST® system 142, a pre-condenser 144, and a second condenser 146. In this figure, the condensate from pre-condenser 144 is collected in condensate receiver 148, which is further processed and/or collected, for example, in blending/feed tank 150. The resulting produced dissolved ammonia gas solution 152 may be further processed and/or collected using the methods and/or systems described herein.

In another set of embodiments, the reaction and separation system comprises a CAST® vaporizer/evaporator system. A CAST® system is a proprietary flash distillation unit operation (e.g., CAST®, commercially available from ThermoEnergy, Inc., Worcester, Mass.). The CAST® system is generally adapted for separating a water stream into a vapor portion and a liquid, bottoms portion, and collecting the bottoms portion which contains a target chemical and/or a chemically modified form thereof (as opposed to an R-CAST® system in which the target chemical and/or a chemically modified form thereof is contained in the distillate/vapor portion). CAST® systems are described in more detail in U.S. Pat. No. 7,270,796, issued Sep. 18, 2007, entitled Ammonium/Ammonia Removal form a Stream and having the inventors Kemp et al., and U.S. Patent Publication No. 2007/0297953 A1, published Dec. 27, 2007, entitled Ammonium/Ammonia Removal form a Stream and having the inventors Kemp et al., each of which is commonly owned by the assignee of the present application and is incorporated herein by reference in its entirety for all purposes. Before, during or after the separation process, the target chemical may optionally be reacted with a reagent and/or subject to other conditions selected to form a chemically modified form of the target chemical. The components and systems described herein for an R-CAST® system may be applied to a CAST® system.

In certain embodiments, an evaporation unit, such as a CAST® system, can be used in a downstream process to concentrate an intermediate or a desired product (e.g., to further concentrate an ammonium sulfate solution after formation thereof in a membrane reactor system).

In another set of embodiments, the reaction and separation system comprises a Turbo CAST® vaporizer/evaporator system. A Turbo CAST® system is a proprietary flash distillation unit operation (e.g., Turbo CAST®, commercially available from ThermoEnergy, Inc., Worcester, Mass.). A Turbo CAST® system is a mechanical vapor recompression (MVR) high temperature system which has a relatively high heat recovery/efficiency. The Turbo-CAST® system may be used as a reaction and separation system for removing a target chemical such as ammonia from a water stream as described herein. In some embodiments, the Turbo-CAST® system is used in place of the R-CAST® system in embodiments described herein. In other embodiments, the Turbo-CAST® system is used in place of a CAST® system in embodiments described herein. A Turbo-CAST® system may be used in applications involving, for example, high flows, low concentrations of target chemical in the water stream, and/or in locations that have high energy costs.

It should be appreciated that while many of the reaction and separation systems described herein refer to the processing of ammonia or ammonium-containing targets, other chemical targets can be used with such and other systems.

The reaction and separation systems may be adapted to treat, for example, at least 500 gallons per day (GPD), at least 1,000 GPD, at least 3,000 GPD, at least 5,000 GPD, at least 10,000 GPD, at least 20,000 GPD, at least 50,000 GPD, at least 100,000 GPD, at least 500,000 GPD, or at least 1,000,000 GPD. Other ranges are also possible. In some embodiments, large amounts of fluids can be treated by, for example, positioning systems described herein in parallel.

### Membrane Reactor Systems and Related Methods

In some embodiments, a system and/or method may comprise or make use of a membrane reactor system and/or related method. In some embodiments, a membrane reactor system may be adapted and arranged to facilitate a reaction between the target chemical and/or a chemically modified form thereof and a reagent to form a desire product.

In one set of embodiments, a membrane of a membrane reactor system may be selected to prevent bulk mixing between first and second solutions in first and second regions of the membrane reactor system, respectively, while allowing transport of one or more particular species across the membrane. For example, the membrane may be selected so as to allow for a target chemical or chemically modified form thereof in a water stream (or processed water stream) to pass through the membrane from the first region to the second region. Those of ordinary skill in the art can choose suitable membranes based on factors such as the specific species to be transported across the membrane and/or the species to be prevented from passing across the membrane, which species may affect the pore size of the membrane, the materials used to form the membrane, the thickness of the membrane, etc. Membranes may also be selected based on factors such as the desired rate of transport of a species across the membrane, the flow rates used, and operational pressures and temperatures. Non-limiting examples of suitable membranes may include ultrafiltration membranes, microfiltration membranes, nanofiltration membranes, and/or gas separation membranes as known to those of ordinary skill in the art. In some embodiments, such membranes may be used for separating out an insoluble component that may be formed by a process described herein. In other embodiments, electrodialysis membranes or reverse osmosis membranes can be used in the methods and systems described herein.

In some embodiments, the membrane reactor system comprises a first region and a second region, wherein the first region and second regions are separated by a membrane. A non-limiting example of a membrane reactor system is shown in FIG. 8. First region 172 is separated from second region 174 by membrane 175. The water stream containing the target chemical is introduced into region 172 and a second solution comprising a reagent is introduced into second region 174. The water stream and the second fluid may be introduced into the regions so that the fluid streams flow in the same direction or in opposite directions. In some cases, the fluids are provided so that the flow is in opposite directions, for example, wherein the water stream is introduced into first region 172 via inlet 176 and exits via outlet 178, and the second fluid enters second region 174 via inlet 182 and exits via outlet 180. In other cases, the fluids are provided so that the flows are in the same direction, for example, wherein the water stream is introduced into first region 172 via inlet 178 and exits via outlet 176, and the second fluid enters second region 174 via inlet 182 and exits via outlet 180.

A membrane reactor system may operate as follows. A water stream comprising a target chemical or chemically modified form thereof may be introduced into the first region of the membrane reactor system. The second region may comprise a second fluid comprising a selected reagent, wherein the reagent reacts with the target chemical and/or chemically modified form thereof to form a desired product. The water stream in the first region may be flowed across the membrane separating the first region and second region, thereby bringing with it at least a portion of the target chemical or chemically modified form thereof. In the second region, at least a portion of the target chemical or chemical modified form thereof which has passed through the membrane may react with the reagent to form a desired product in the second region of the membrane reactor system. The solution comprising the product may then be collected (e.g., using a collection system which is in fluid communication with the membrane reactor system) and/or introduced into any other desired system (e.g., a system adapted to and arranged to concentrate the product).

As described above, suitable membranes for use in the membrane reactor system can be selected by those of ordinary skill in the art from amongst known membrane materials and types using no more than routine skill in the art as informed by the present description of the inventions herein. In some embodiments, the membrane allows for gaseous target chemicals to pass through the membrane. Accordingly, in some embodiments, the water stream introduced into the first region comprises a gas and/or a dissolved gas, wherein upon exposure to the membrane, the gas and/or dissolved gas passes through the membrane to the second region. The gas in the second region may react with the reagent to form a product, which in some embodiments, is a solute. In other embodiments, the product may be a precipitate. In some embodiments, the membrane reactor system may be a tangential flow device such as a tangential flow hollow fiber filtration system. In other embodiments, other membrane systems such as a flat plate membrane, pleated membrane, or spiral membrane can be used. Monolithic tubular membranes can also be used.

In other embodiments, the water stream introduced into the first region comprises a non-gaseous solute, wherein upon exposure to the membrane, the non-gaseous solute passes through the membrane to the second region. The non-gaseous solute in the second region may react with the reagent to form a product, which in some embodiments, is a solute. In other embodiments, the product may be a precipitate.

The water stream introduced into the membrane reactor system comprising the target chemical or a chemically modified form thereof may be provided from any suitable source. For example, as described herein, prior to being supplied to the membrane reactor system, the fluid stream may have been treated and/or exposed to a reverse osmosis system and/or a reaction and separation system. That is, the membrane reactor system may be in fluid communication with any suitable number of other systems, for example, a reverse osmosis system and/or a reaction and separation system.

In some embodiments, two or more membrane reactor systems can be connected in series. For example, the outlet of a first membrane reactor system can be in fluid communication with the inlet of a second membrane reactor system, such that a water stream passes through the two systems in series. In such embodiments including two or more membrane reactor systems, a target chemical may be removed from a water stream to a greater extent compared to the use of a single membrane reactor system. Other configurations are also possible (e.g., systems connected in parallel).

The second fluid which is used in connection with the membrane reactor system (e.g. which is provided to the second region), may comprise one or more suitable reagents, wherein the one or more reagents react with the target chemical and/or chemically modified form thereof to form a product. In many embodiments, the second fluid comprises water, or is water that contains a dissolved solute. As described in more detail here in, those of ordinary skill in the art will be able to select suitable reagents for use with the target chemical or chemically modified form thereof. In some cases, the one or more reagents are selected so as to react with the target chemical or chemically modified form thereof in a first phase (e.g., a gaseous phase or a dissolved gas) to form a product which is in a second, different phase (e.g., a dissolved or non-gaseous solute or a precipitate). In one embodiment, the target chemical or chemically modified form thereof is a dissolved gas and the product is a dissolved solute.

Those of ordinary skill in the art will be able to determine suitable concentrations for the reagent in the second solution. In addition, those of ordinary skill in the art will be aware of suitable methods and/or system for providing the second fluid comprising the reagent to the membrane reactor system. For example, in some cases the inlet of the second region of a membrane reactor system may be in fluid connection with a container comprising the second fluid containing the reagent. In other cases, a container comprising the second fluid absent of the reagent may be in fluid communication with the membrane reactor system, and a second container comprising the reagent may also be in fluid communication with the second region of the membrane reactor system, wherein appropriate amounts of the reagent may be added to the second fluid prior to providing the second fluid to the second region of the membrane system.

In an exemplary embodiment, the target chemical or chemically modified form thereof is dissolved ammonia gas, wherein the ammonium gas passes through the membrane to the second region of the membrane reactor system. The fluid stream in the second region comprises water and an acid, wherein the acid reacts with the ammonium gas which is passed through the membrane to form a solution comprising an ammonium salt. In some embodiments, wherein the target chemical or chemically modified form thereof is dissolved ammonia gas, the reagent is an acid. Suitable acids for use as a reagent are described herein.

### Reverse Osmosis Systems and Related Methods

In some embodiments, a system or method of the present invention makes use of a reverse osmosis system and/or related methods. As described above, a reverse osmosis system is generally adapted and arranged to concentrate and/or purify a target chemical in the wastewater and form a retentate comprising a de-watered, more concentrated solution of the target chemical.

As will be known to those of ordinary skill in the art, reverse osmosis (“RO”) is a membrane separation process that may be used to purify water by applying pressure to force water through a semi-permeable membrane, while leaving the majority of impurities on the feed side of the membrane. The RO membrane typically allows water to pass through, while retaining a large percentage of the solute molecules, for example, the target chemical. The “permeate,” or solvent water which passes through the membrane, typically has significantly less contamination than the feed water. The “retentate” stream, which remains upstream of the membrane, typically has higher concentrations of solute molecules than the permeate stream. Accordingly, during this process, the target chemical is concentrated and passed out of the system in the retentate stream, while purified water passes out of the system in the permeate stream.

In the case of ammonium, the permeate stream may be, for example, approximately 70-75% of the total flow and can be discharged in compliance within the federal or state guidelines regarding ammonium limitations. The retentate may be approximately 25-30% of the total flow and can be further processed as described herein. Use of a reverse osmosis system/method increases the ammonium concentration and helps to reduce the flow rate and/or amount of the wastewater fed to the additional components/systems. This increase in ammonia concentration and/or reduction in flow rate or amount can increase the efficiency and reduce the size of a system/method for ammonium removal/recovery (e.g., by reducing the energy requirements to process the water stream). The increase in efficiency can substantially reduce the associated capital and/or operating costs.

Reverse osmosis systems and methods will generally be known to those of ordinary skill in the art. Generally, a reverse osmosis system comprises an inlet for the water source, a first compartment and a second compartment, wherein the first compartment and second compartment are separated by a membrane, an outlet for the permeate, and an outlet for the retentate.

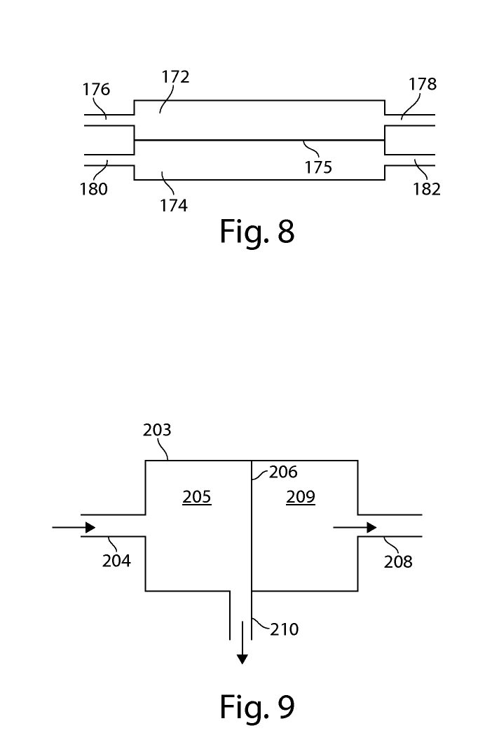

FIG. 9 depicts a non-limiting example of a reverse osmosis system. Water source from inlet 204 enters the system 203. The water enters into compartment 205 which is in fluid connection with membrane 206. Pressure is applied on side 205 and a portion of the water stream passes through membrane 206, thereby forming a permeate solution in compartment 209, which may exit the system via outlet 208. The retentate from compartment 205 may exit the system via outlet 210. The permeate can be used and/or disposed of accordingly, and the retentate may transported to another component of a system as described herein (e.g., a membrane reactor system, reaction and separation system).

The reverse osmosis system can comprise one or more suitable membranes. For example, the membrane may comprise a single RO membrane or multiple RO membranes in series and/or parallel. Membranes having various rejection rates or molecular weight cutoffs are possible. Reverse osmosis membranes and suitable arrangements will be known to those of ordinary skill in the art. Generally, the membrane may be essentially any suitable membrane able to remove or reduce contaminants, selected particulates, undesirable chemical species (for example, iron or copper) or the like.

### Water Sources

Those of ordinary skill in the art will be aware of suitable water sources to be used in connection with the methods and systems described herein. In some embodiments, the water source comprises wastewater. Wastewater may be discharged from sources such as domestic residences, commercial properties, industry, and/or agriculture. In some cases, the wastewater is municipal wastewater. In some embodiments, wastewater includes one or more components such as human waste, blackwater, cesspit leakage, septic tank discharge, sewage treatment plant discharge, greywater or washing water, rainfall, groundwater, manufactured liquids from domestic sources (e.g., drinks, cooking oil, pesticides, lubricating oil, paint, cleaning liquids, etc.), runoff from roads, car parks, roofs, sidewalks, or pavements, seawater ingress, river water, manmade liquids, highway drainage, storm drainage, industrial waste, industrial site drainage, industrial cooling waters, industrial process waters, organic or bio-degradable waste, organic or non bio-degradable/difficult-to-treat waste, extreme pH waste, toxic waste, solids and emulsions (e.g., from paper manufacturing, foodstuffs, lubricating and hydraulic oil manufacturing, etc.), and agricultural drainage. Wastewater may include, in some embodiments, high concentrations of contaminants such as bacteria, salt, biocides, pesticides, or pharmaceutical wastes,

In other embodiments, the water source comprises process water, i.e., water which is being used in connection with a chemical process or method. Process water may include, for example, boiler feed water, cooling water for heat exchangers or engines, water for chemical dilution, and water used in the manufacturing of a chemical or reagent.

Generally the water for use in the systems and methods described herein comprises at least one target chemical to be recovered and/or removed from a water stream.

### Pre-Processing Systems and Methods

The methods and/or systems described herein may be used in combination with any other number of system components and/or method steps to process the water stream prior to providing the water stream to a system or method as described herein, for example, in order to optimize performance and/or efficiencies of the methods and/or systems. In particular, additional systems and/or method steps will be known to those of ordinary skill in the art for use in combination with wastewater treatment systems and/or methods. Non-limiting examples of additional components include dissolved air flotation, multimedia filtration, ultraviolet irradiation, ion exchange softening, ultrafiltration, chemical treatment systems (e.g., for chlorination, ozonation, peroxidation and the like) and additional reverse osmosis systems.

As will be known to those of ordinary skill in the art, dissolved air flotation (DAF) is a water treatment process that comprises clarifying wastewaters (or other waters) by the removal of suspended matter such as oil or solids. The removal is achieved by dissolving air in the water or wastewater under pressure and then releasing the air at atmospheric pressure in a flotation tank or basin. The released air forms tiny bubbles which adhere to the suspended matter causing the suspended matter to float to the surface of the water where it may then be removed by a skimming device. DAF systems and methods are commercially available and will be known to those of ordinary skill in the art.

In some embodiments, the system and/or method may comprise one or more filtration processes and/or systems. Those of ordinary skill in the art will be aware to suitable filtration processes and/or systems for use with the methods and/or systems described herein. Non-limiting examples of types of filtration processes and/or systems include simple filtration, microfiltration, nanofiltration, multi-media filtration, and ultrafiltration.

Multi-media filtration makes use of a depth filter that comprises two or more types of media and gravel under-bedding. Generally, the gravel support prevents smaller media from entering the distribution system and stops channeling of water. The coarse media layers in the top of the tank trap large particles, and smaller particles are trapped in the finer layers of media deeper in the filtering bed. Multi-media filtration can result in a highly efficient filtering, since removal takes place throughout the entire bed. Multi-media filters typically remove particles 5 to 15 microns in size as opposed to a conventional single media sand filter which removes 30 micron or higher. Multi-media filter systems and methods are commercially available and will be known to those of ordinary skill in the art.

Ultrafiltration (UF) generally makes use of a semi-permeable membrane filtration process that removes colloidal suspended solids and high molecular weight solutes by applying pressure on one side of the membrane. The retained solids and solutes are concentrated in the reject stream, while water and low molecular weight solutes pass through the membrane in the permeate stream. The ultrafiltration may provide fouling protection for a reverse osmosis (RO) unit. In some embodiments, the reject stream is approximately 10% of the total flow and may be fed directed to a reaction and separation system described herein (e.g., for ammonia removal). In some embodiments, the permeate flow is approximately 90% of the total flow and may be provided to a reverse osmosis (RO) system as described herein. Ultrafiltration systems and methods are commercially available and will be known to those of ordinary skill in the art.

As will be known to those of ordinary skill in the art, ultraviolet (UV) irradiation is a disinfection process which comprises using ultraviolet light at sufficiently short wavelength to kill bacteria and/or inhibit bacteriological growth. The ultraviolet irradiation process can serve to reduce bacteriological growth and contamination in downstream processes that could compromise their performance. Ultraviolet irradiation systems and methods are commercially available and will be known to those of ordinary skill in the art.

Ion exchange softening generally comprises reducing the concentration of hard metal cations (e.g., calcium, magnesium) in hard water in which a cation resin exchanges another cation (e.g., sodium) for the various hardness ions. The ion exchange softening process aids in preventing struvite formation and/or precipitation of sparingly soluble salts that could foul system and piping components downstream. Ion exchange softening systems and methods are commercially available and will be known to those of ordinary skill in the art.

A non-limiting example of a system comprising a plurality of pre-process steps/systems is shown in FIG. 4. This system comprises dissolved air flotation system 112, multimedia filtration system 114, a micron cartridge filtration system 116, ultraviolet sterilizer system 118, ion exchange softener system 120, and ultrafiltration system 122. Examples of suitable ion exchange softener systems are described in more detail in U.S. Pat. No. 7,270,796, issued Sep. 18, 2007, entitled Ammonium/Ammonia Removal from a Stream and having the inventors Kemp et al., which is commonly owned by the assignee of the present application, ThermoEnergy, Inc., and is incorporated herein by reference in its entirety for all purposes.

In the system in FIG. 4, ultrafiltered permeate is provided to reverse osmosis system 104, and the methods and systems described herein may then be present/employed (e.g., reaction and separation system 126, membrane reactor system 128, etc.). It should be appreciated that while multiple pre-processing systems are shown in FIG. 4, in other embodiments, not all components need be present. In certain embodiments, one or more of the pre-processing systems are included in a water treatment system. Other pre-processing systems can also be included in the systems and methods described herein.

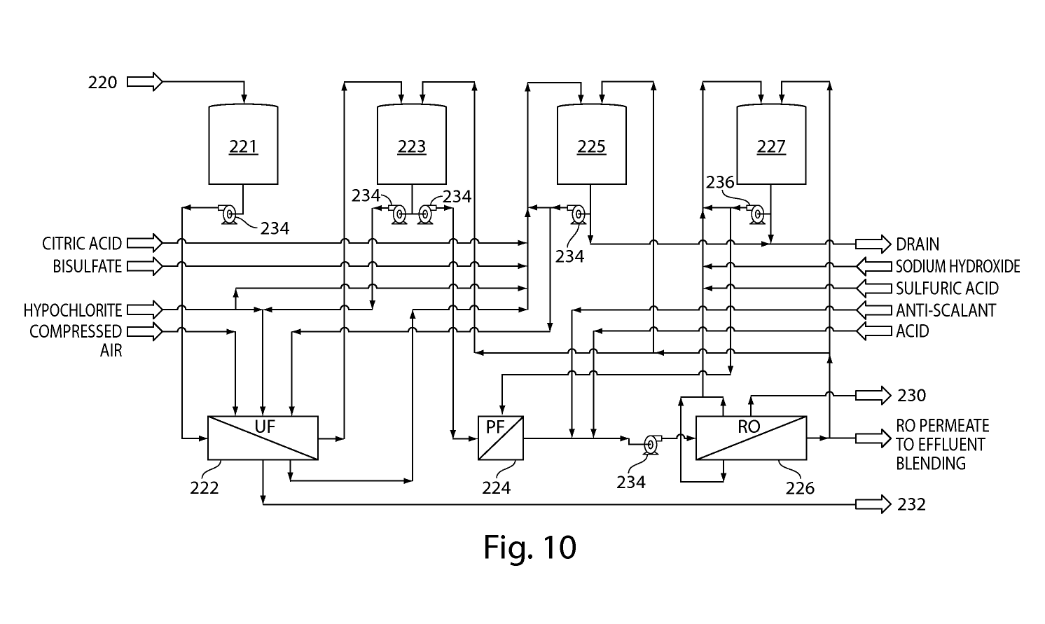

Another example of a system is shown in FIG. 10. The system in this figure comprises an ultrafiltration system 222 which in fluid communication with water stream 220, via the ultrafiltration feed tank 221. The output from the ultrafiltration is optionally processed via feed tank 223, and then provided to particle filtration system 224, which is then provided to reverse osmosis system 226. The reverse osmosis retentate 230 from the reverse osmosis system and/or the ultrafiltration backwash 232 can then be further processed as described herein (e.g., by providing to a reaction and separation system and/or a membrane reactor system). The system may comprise any suitable number of additional components, including, but not limited to, one or more storage tanks for intermediate solutions (e.g., 225, 227), pump(s) (e.g., 234), heater(s), venturi(s), inlets, outlets, collection system(s) for the waste solutions and/or products, etc.

### Post-Processing Systems and Methods, and Collection Systems and Methods

As described above, the methods and/or systems of the present invention may be used in combination with any other number of system components or method steps to process the water following use of a system or method as described herein for processing water. In particular, additional systems and/or method steps will be known to those of ordinary skill in the art for use in combination with wastewater treatment systems and methods. Non-limiting examples of additional components include dissolved air flotation, multimedia filtration, ultraviolet irradiation, ion exchange softening, ultrafiltration, and additional reverse osmosis systems, as described herein.

In some embodiments, following production of a fluid comprising a target chemical, chemically modified form thereof, or a product according to the methods and/or systems described herein, the solution may be further purified and/or concentration using methods and systems which will be known to those of ordinary skill in the art. In some embodiments, the solution may be further concentrated and/or purified using a reverse osmosis system. In other embodiments, the solution may be further concentrated and/or purified using an R-CAST® or a CAST® system, wherein either the vapor portion or the bottoms portion, respectively, contain the target chemical, chemically modified form thereof, or the product.

Those of ordinary skill in the art will be aware of suitable collections systems for use with the methods and/or systems described herein. In some embodiments, a collection system is in fluid connection with the final system using in the processing and/or production of a fluid comprising the target chemical, chemically modified form thereof, or the product. The collection system may comprise one or more containers for collecting the solution.

The following references are incorporated by reference herein in their entirety for all purposes:

U.S. Pat. No. 7,270,796, issued Sep. 18, 2007, entitled Ammonium/Ammonia Removal from a Stream and having the inventors Kemp et al.;

U.S. Patent Publication No. 2007/0297953 A1, published Dec. 27, 2007, entitled Ammonium/Ammonia Removal from a Stream and having the inventors Kemp et al.;

U.S. Pat. No. 4,770,748, issued Sep. 13, 1988, entitled “Vacuum Distillation System” and having the inventors Cellini et al.;

U.S. Pat. No. 4,880,504, issued Nov. 14, 1989, entitled Vacuum Distillation System with Spiralled Cold Coil and having the inventors Cellini et al.;

Environmental Protection Agency, Process Design Manual for Nitrogen Control, US Government Printing Office, Washington, D.C. (1975);

National Academy of Sciences, Nitrates: An Environmental Assessment, US Government Printing Office, Washington, D.C. (1978);

Benefield, Judkins and Weand, Process Chemistry for Water and Wastewater Treatment, Prentice Hall, Inc, Englewood Cliffs, N.J. (1982);

Minton, Handbook of Evaporation Technology, Noyes Publications, Park Ridge, N.J. (1986);

Dagger, Waltrip, Romm and Morales, Enhanced Secondary Treatment Incorporating Biological Nutrient Removal, Journal WPCF, vol. 60, no. 10 (1988); and

Tchnobanoglous and Burton, Wastewater Engineering, Treatment, Disposal and Reuse, third edition, Metcalf & Eddy, Inc., McGraw-Hill, New York, N.Y. (1991).

The following examples are included to demonstrate various features of the invention. Those of ordinary skill in the art should, in light of the present disclosure, will appreciate that many changes can be made in the specific embodiments which are disclosed while still obtaining a like or similar result without departing from the scope of the invention as defined by the appended claims. Accordingly, the following examples are intended only to illustrate certain features of the present invention, but do not necessarily exemplify the full scope of the invention.

### EXAMPLES

### Example 1

This example describes results obtained from a reverse osmosis system used for pre-concentrating an ammonium/ammonia target chemical. This example shows that a solution containing ammonium/ammonia can be pre-concentrated using a reverse osmosis system for delivery to a reaction and separation system described herein.

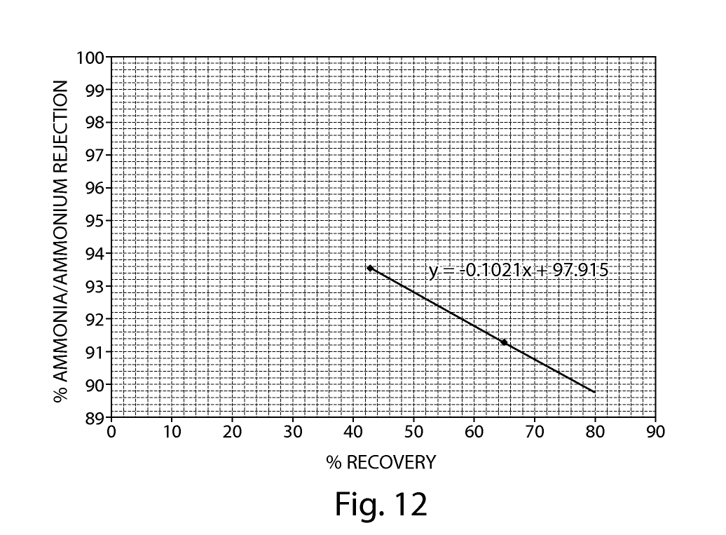

A reverse osmosis system was operated according to the conditions described in Table 1. A plot of the results in shown in FIG. 12. The percent ammonia/ammonium rejection is equal to the concentration of the ammonia/ammonium in the feed minus the concentration of the ammonia/ammonium in the permeate, divided by the concentration of ammonia/ammonium in the feed. The percent system recovery is equal to the volume of the feed provided to the system minus the volume of the retentate, divided by the volume of the feed. Generally, as the percent recovery increases, the percent ammonia/ammonium rejection decreases. For system wherein the retentate from the reverse osmosis is further processed using an R-CAST® system, the decrease in ammonia/ammonium rejection may be balanced by overall improvements in energy efficiency of the system as less volume of water would need to be processed by the R-CAST® system.

In the table, AK4021T1773 is a low pressure low salt rejection membrane and TW30-4021 is a high rejection/higher pressure membrane. Runs 2, 4 and 6 were pH adjusted of runs 1, 3 and 5 respectively. H₂SO₄ was used to reduce the pH as noted in the table. Off-gassing was observed in the feed tank. For Run 7, the permeate and brine were collected in separate buckets. When pump cavitated, the RO system was turned off. The brine was poured back into the feed tank to simulate a 65% recovery of a two stage RO system. The results are tabulated in Table 1.

TABLE 1

| | Run # | | | | | | | |
|---|---|---|---|---|---|---|---|---|
| | 1 | 2 | 3 | 4 | 5 | 6 | 7 | 8 |
| Membrane Model | AK4021T1773 | AK4021T1773 | TW30-4021 | TW30-4021 | TW30-4021 | TW30-4021 | TW30-4021 | TW30-4021 |
| Date | Nov. 7, 2011 | Nov. 7, 2011 | Nov. 9, 2011 | Nov. 9, 2011 | Nov. 10, 2011 | Nov. 10, 2011 | Nov. 11, 2011 | Nov. 11, 2011 |
| Feed type | Synthetic | Synthetic | Synthetic | Synthetic | NY Centrate | NY Centrate | NY Centrate | Brine fun #7 |
| Feed Flowrate | 1969 | 1947 | 1317 | 1227 | 1473 | 1530 | 1750 | 1738 |
| (ml/min) | | | | | | | | |
| Feed Temp (C.) | 25 | 25 | 25 | 25 | 25 | 25 | 28 | 32 |
| Feed pH | 7.9 | 6.5 | 8.1 | 6.7 | 7.4 | 6.6 | 7.3 | 7.4 |
| H2SO4 used (ml per | None | 42 | None | 42 | None | 10 | None | None |
| 50 liter feed) | | | | | | | | |
| Feed Pressure (psig) | 150 | 150 | 150 | 150 | 150 | 150 | 150 | 150 |
| Feed Conductivity | 7430 | 8060 | 9740 | 10570 | 5450 | 5720 | 5080 | 9450 |
| (uS/cm) | | | | | | | | |
| Feed Ammonia | 1370 | 1386 | 1830 | 1516 | 650 | 629 | 650 | 945 |
| (ppm) | | | | | | | | |
| Permeate Flow rate | 1103 | 1156 | 480 | 444 | 655 | 692 | 750 | 679 |
| (ml/min) | | | | | | | | |
| Permeate | 1946 | 1557 | 1536 | 1296 | 386 | 423 | 514 | 800 |
| Conductivity | | | | | | | | |
| (uS/cm) | | | | | | | | |
| Permeate Ammonia | 318 | 215 | 249 | 122 | 41 | 39 | 42 | 85 |
| (ppm) | | | | | | | | |
| Brine Flowrate | 856 | 791 | 837 | 703 | 818 | 837 | 1000 | 1059 |
| (ml/min) | | | | | | | | |
| Brine Conductivity | 13840 | 16220 | 14250 | 17060 | 9450 | 10100 | 10360 | 14460 |
| (uS/cm) | | | | | | | | |
| Brine Ammonia | 2844 | 3372 | 2723 | 2546 | 1259 | 1228 | 1231 | 1707 |
| (ppm) | | | | | | | | |
| Run time (min) | 30 | 30 | 30 | 30 | 30 | 30 | 30 | 30 |
| System Recovery | 56% | 59% | 36% | 36% | 44% | 45% | 43% | 39% |
| (%) | | | | | | | | |
| Ammonia Rejection | 87% | 91% | 95% | 97% | 97% | 97% | 97% | 96% |
| (%) | | | | | | | | |
| Conductivity | 85% | 89% | 94% | 96% | 97% | 97% | 96% | 97% |
| Rejection (%) | | | | | | | | |
| Total Feed | 2697530 | 2657655 | 2410908 | 1860794 | 957327 | 961699 | 1136942 | 1642716 |
| Ammonia | | | | | | | | |
| Total Permeate | 350754 | 248540 | 119631 | 54200 | 26646 | 26923 | 31506 | 57783 |
| Ammonia | | | | | | | | |
| Total Brine | 2462904 | 2667252 | 2279388 | 1992889 | 1030499 | 1028471 | 1231431 | 1807013 |
| Ammonia | | | | | | | | |
| % Difference | −4% | −10% | 0% | −10% | −10% | −10% | −11% | −14% |

### Example 2

This example describes removal of a target chemical from a water stream using an R-CAST® system, wherein the target chemical is ammonium/ammonia.

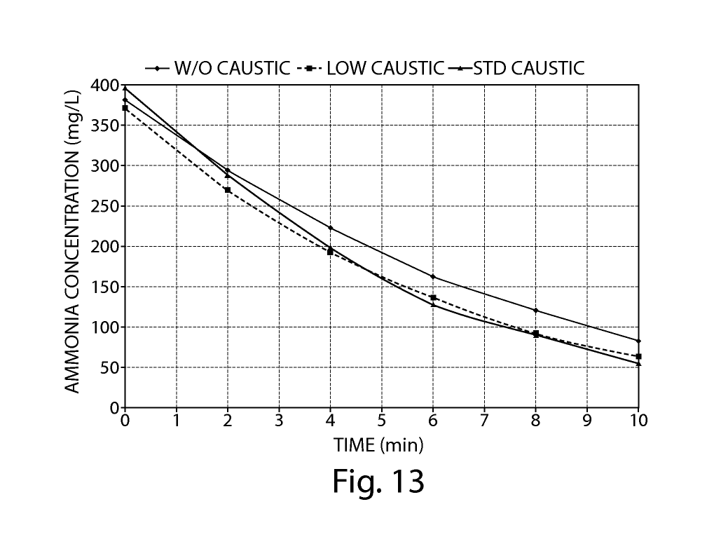

In this example, a feed comprising ammonia was provided to an R-CAST® system and circulated (e.g., so that the bottoms is constantly being circulated in the R-CAST®). The R-CAST® was operated at temperatures between about 81 and 93° C. The parameters for the R-CAST® system and some data is shown in Table 2. The system was run under three sets of pH conditions: 1) No caustic added, pH of about 8.9-9.4; 2) Low caustic conditions, pH of about 9.6-9.7; and 3) Normal caustic, pH of about 11.0 to 13.3. The concentration of ammonia in the bottoms was measured over time and the results are shown in FIG. 13.

TABLE 2

| Ammonia | | Am- | | | | | Dis- | Strip- |
|---|---|---|---|---|---|---|---|---|
| Conc | | monia | | | | Recirc | tillate | ping |
| (mg/L | | Re- | Feed | | | Flow | Flow | Effi- |
| NH3—NH3) | | duction | Temp | Caustic | Initial | Rate | Rate | cien- |
| Initial | Final | (%) | (° C.) | Level | pH | (GPM) | (LPM) | cy |
| 599 | 366 | 38.9 | 83 | none | 9.2 | 14 | 0.67 | 0.290 |
| 511 | 320 | 37.4 | 87 | none | 9.3 | 14 | 0.50 | 0.360 |
| 546 | 326 | 40.3 | 89 | none | 9.3 | 14 | 0.67 | 0.310 |
| 382 | 83 | 78.3 | 85 | none | 9.4 | 21 | 0.71 | 0.450 |
| 358 | 117 | 67.3 | 81 | none | 9.3 | 21 | 0.61 | 0.400 |
| 437 | 145 | 66.8 | 82 | none | 9.4 | 21 | 0.62 | 0.388 |
| 485 | 114 | 76.5 | 86 | none | 9.4 | 24 | 0.79 | 0.390 |
| 469 | 114 | 76.7 | 87 | none | 9.3 | 24 | 0.80 | 0.375 |
| 421 | 108 | 74.3 | 86 | none | 9.3 | 24 | 0.67 | 0.430 |
| 1787 | 190 | 89.4 | 84 | none | | 24 | 1.20 | 0.377 |
| 1019 | 131 | 87.1 | 84 | none | | 24 | 1.70 | 0.242 |
| 2034 | 264 | 87.0 | 89 | none | 9.2 | 24 | 1.40 | 0.296 |
| 1142 | 145 | 87.3 | 92 | none | 9.0 | 24 | 1.65 | 0.248 |
| 965 | 120 | 87.6 | 88 | none | 9.0 | 24 | 1.70 | 0.244 |
| 1182 | 126 | 89.3 | 89 | none | 8.9 | 24 | 1.70 | 0.259 |
| 1231 | 130 | 89.4 | 92 | none | 9.0 | 24 | 1.40 | 0.318 |
| 1190 | 152 | 87.2 | 92 | none | 8.9 | 24 | 1.40 | 0.295 |
| 463 | 212 | 54.2 | 90 | low | 9.6 | 14 | 0.48 | 0.580 |
| 420 | 179 | 57.4 | 93 | low | 9.7 | 12 | 0.53 | 0.570 |
| 340 | 124 | 63.5 | 88 | low | 9.6 | 12 | 0.60 | 0.600 |
| 413 | 73 | 82.3 | 82 | low | 9.6 | 21 | 0.60 | 0.600 |
| 427 | 73 | 82.4 | 82 | low | 9.6 | 21 | 0.60 | 0.600 |
| 371 | 64 | 82.7 | 83 | low | 9.6 | 21 | 0.62 | 0.585 |
| 349 | 35 | 90.0 | 86 | low | 9.5 | 24 | 0.790 | 0.590 |
| 321 | 30 | 90.7 | 86 | low | 9.6 | 24 | 0.680 | 0.710 |
| 297 | 23 | 92.3 | 86 | low | 9.6 | 24 | 0.770 | 0.670 |
| 350 | 94 | 73.1 | 86 | normal | 11.6 | 12 | 0.80 | 0.355 |
| 339 | 90 | 73.5 | 87 | normal | 12.3 | 12 | 0.82 | 0.350 |
| 190 | 59 | 68.9 | 88 | normal | 12.4 | 12 | 0.67 | 0.390 |
| 396 | 56 | 85.9 | 83 | normal | 11.7 | 21 | 0.61 | 0.660 |
| 400 | 61 | 84.8 | 84 | normal | 12.2 | 21 | 0.59 | 0.660 |
| 326 | 56 | 82.8 | 84 | normal | 12.3 | 21 | 0.60 | 0.610 |
| 289 | 17 | 94.1 | 86 | normal | 12.1 | 24 | 0.69 | 0.820 |
| 275 | 13 | 95.3 | 86 | normal | 12.4 | 24 | 0.78 | 0.780 |
| 265 | 16 | 94.0 | 86 | normal | 12.5 | 24 | 0.69 | 0.820 |
| 1054 | 3.6 | 99.7 | 89 | normal | 11.0 | 24 | 1.80 | 0.540 |
| 1403 | 12 | 99.1 | 87 | normal | 13.3 | 24 | 1.60 | 0.535 |

### Example 3

This example describes removal of a target chemical from a water stream using an R-CAST® system employing a pre-condenser and a second condenser, wherein the target chemical is ammonium/ammonia.

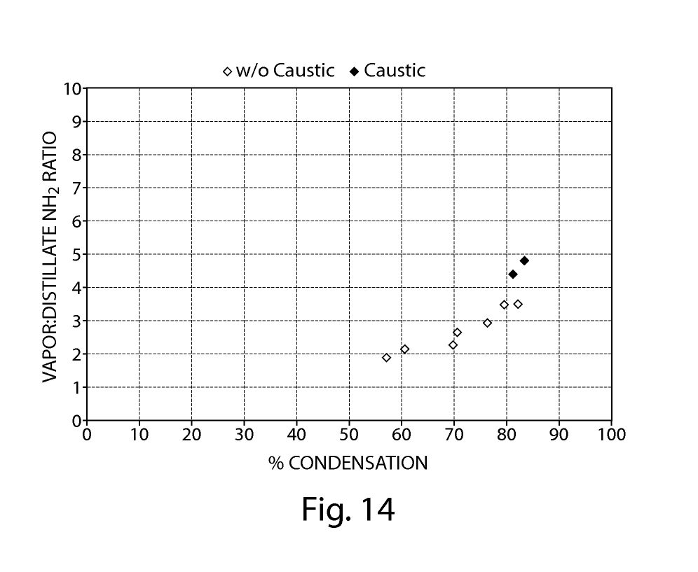

In this example, a feed comprising ammonia was provided to an R-CAST® system and circulated. The vapor from the R-CAST® was condensed via a pre-condenser and a second condenser. See, for example, the system shown in FIG. 7. The parameters for the R-CAST® system and some data is shown in Table 3. The R-CAST® was operated at a temperature between about 84 and 92° C. The system was run under two sets of pH conditions: 1) No caustic added, pH of about 8.9-9.6; 2) Normal caustic, pH of about 10.7 to 13.3. The concentration of ammonia in the condensate in receiver 148 (see FIG. 7) from pre-condenser 144 and the concentration in the vapor off of pre-condenser 144 were measured, either directly or indirectly (e.g., for the vapor, the concentration was determined by calculating the mass balance, wherein the mass balance was the difference in the ammonia concentration between the feed and the condensate bottoms). FIG. 14 shows a plot of the concentration of ammonia in the vapor from the pre-condenser versus the concentration ratio of the ammonia in the distillate from the pre-condenser. As the plot shows, the ratio of ammonia in the vapor:distillate increases with an increasing amount of condensate formed at the pre-condenser.

TABLE 3

| | | | | | | |
|---|---|---|---|---|---|---|
| PARAMETER | UNITS | RUN #3 | RUN #4 | RUN #5 | RUN #6 | RUN #7 |

Raw data/Calculations

| | | | | | | |
|---|---|---|---|---|---|---|
| Initial Batch Volume | L | 38.0 | 38.0 | 38.0 | 38.0 | 38.0 |
| Final Batch Volume | L | 26.0 | 21.0 | 24.0 | 21.5 | 21.0 |
| Distillate Volume | L | 12.0 | 17.0 | 14.0 | 16.5 | 17.0 |
| Condensate Volume | L | 11.0 | 12.0 | 11.5 | 11.5 | 13.0 |
| Vapor Volume | L | 1.0 | 5.0 | 2.5 | 5.0 | 4.0 |
| Run Time | min | 10.0 | 10.0 | 10.0 | 10.0 | 10.0 |
| Distillate Flow Rate | L/min | 1.20 | 1.70 | 1.40 | 1.65 | 1.70 |
| Condensate Level | % | 91.67 | 70.59 | 82.14 | 69.70 | 76.47 |
| Vapor Level | % | 8.33 | 29.41 | 17.86 | 30.30 | 23.53 |
| Feed Temperature | ° C. | 84 | 84 | 89 | 92 | 88 |
| Condensate Temperature | ° C. | 55 | 55 | 55 | 36 | 50 |
| Vapor Temperature | ° C. | N/A | N/A | 82 | 86 | 80 |
| Initial pH | — | N/A | N/A | 9.2 | 9.0 | 9.0 |
| Final pH | — | N/A | N/A | 9.5 | 9.6 | 9.5 |
| Initial NH₃—N Conc | mg/L | 1470 | 838 | 1673 | 939 | 794 |
| Final NH₃—N Conc | mg/L | 156 | 108 | 217 | 119 | 99 |
| Condensate NH₃—N Conc | mg/L | 1546 | 518 | 1905 | 903 | 666 |
| Initial NH₃ Conc | mg/L | 1787 | 1019 | 2034 | 1142 | 965 |
| Final NH₃ Conc | mg/L | 190 | 131 | 264 | 145 | 120 |
| Condensate NH₃ Conc | mg/L | 1880 | 630 | 2316 | 1098 | 810 |
| NH₃ in Initial Batch | moles | 3.988 | 2.273 | 4.539 | 2.547 | 2.154 |
| NH₃ in Final Batch | moles | 0.290 | 0.162 | 0.372 | 0.183 | 0.148 |
| NH₃ in Distillate | moles | 3.698 | 2.112 | 4.167 | 2.365 | 2.006 |
| NH₃ in Condensate | moles | 1.214 | 0.444 | 1.564 | 0.741 | 0.618 |
| NH₃ in Vapor | moles | 2.484 | 1.668 | 2.603 | 1.623 | 1.388 |
| Initial NH₃ Mole Fraction | — | 0.001890 | 0.001078 | 0.002151 | 0.001208 | 0.001021 |
| Final NH₃ Mole Fraction | — | 0.000201 | 0.000139 | 0.000279 | 0.000153 | 0.000127 |
| Distillate NH₃ Mole Fraction | — | 0.005552 | 0.002238 | 0.005362 | 0.002582 | 0.002125 |
| Condensate NH₃ Mole Fraction | — | 0.001988 | 0.000666 | 0.002450 | 0.001161 | 0.000857 |
| Vapor NH₃ Mole Fraction | — | 0.044755 | 0.006009 | 0.018756 | 0.005849 | 0.006249 |
| Initial NH₃ Wt Fraction | — | 0.001787 | 0.001019 | 0.002034 | 0.001142 | 0.000965 |
| Final NH₃ Wt Fraction | — | 0.000190 | 0.000131 | 0.000264 | 0.000145 | 0.000120 |
| Distillate NH₃ Wt Fraction | — | 0.005251 | 0.002116 | 0.005071 | 0.002441 | 0.002010 |
| Condensate NH₃ Wt Fraction | — | 0.001880 | 0.000630 | 0.002316 | 0.001098 | 0.000810 |
| Vapor NH₃ Wt Fraction | — | 0.042414 | 0.005683 | 0.017750 | 0.005531 | 0.005910 |
| % of Total Ammonia Stripped | % | 92.74 | 92.88 | 91.81 | 92.83 | 93.11 |
| % of Stripped Ammonia in Vapor | % | 67.17 | 78.98 | 62.47 | 68.65 | 69.18 |
| % of Stripped Ammonia in Condensate | % | 32.83 | 21.02 | 37.53 | 31.35 | 30.82 |

Actual Data

| Distillate NH₃ Mole Fract-Actual | — | 0.005552 | 0.002238 | 0.005362 | 0.002582 | 0.002125 |
|---|---|---|---|---|---|---|
| Condensate NH₃ Mole Fract-Actual | — | 0.001988 | 0.000666 | 0.002450 | 0.001161 | 0.000857 |
| Vapor NH₃ Mole Fract-Actual | — | 0.044755 | 0.006009 | 0.018756 | 0.005849 | 0.006249 |
| Distillate NH₃ Wt Fraction-Actual | — | 0.005251 | 0.002116 | 0.005071 | 0.002441 | 0.002010 |
| Distillate NH₃ Wt Conc-Actual | wt % | 0.53 | 0.21 | 0.51 | 0.24 | 0.20 |
| Condensate NH₃ Wt Fraction-Actual | — | 0.001880 | 0.000630 | 0.002316 | 0.001098 | 0.00810 |
| Condensate NH₃ Wt Conc-Actual | mg/L | 1880 | 630 | 2316 | 1098 | 810 |
| Vapor NH₃ Wt Fraction-Actual | — | 0.042414 | 0.005683 | 0.017750 | 0.005531 | 0.005910 |
| Vapor NH₃ Wt Conc-Actual | wt % | 4.24 | 0.57 | 1.78 | 0.55 | 0.59 |
| Vapor:Distillate NH₃ Conc Ratio | — | 8.06 | 2.69 | 3.50 | 2.27 | 2.94 |
| Vapor:Condensate NH₃ Conc Ratio | — | 22.51 | 9.02 | 7.66 | 5.04 | 7.30 |
| Vapor:Feed NH₃ Conc Ratio | — | 23.67 | 5.58 | 8.72 | 4.84 | 6.12 |
| % of Stripped Ammonia in Vapor | % | 67.17 | 78.98 | 62.47 | 68.65 | 69.18 |
| % of Stripped Ammonia in Condensate | % | 32.83 | 21.02 | 37.53 | 31.35 | 30.82 |
| PARAMETER | UNITS | RUN #8 | RUN #9 | RUN #10 | RUN #11 | RUN #12 |

Raw data/Calculations

| | | | | | | |
|---|---|---|---|---|---|---|
| Initial Batch Volume | L | 38.0 | 38.0 | 38.0 | 38.0 | 38.0 |
| Final Batch Volume | L | 21.0 | 24.0 | 24.0 | 20.0 | 22.0 |
| Distillate Volume | L | 17.0 | 14.0 | 14.0 | 18.0 | 16.0 |
| Condensate Volume | L | 13.5 | 8.5 | 8.0 | 15.0 | 13.0 |
| Vapor Volume | L | 3.5 | 5.5 | 6.0 | 3.0 | 3.0 |
| Run Time | min | 10.0 | 10.0 | 10.0 | 10.0 | 10.0 |
| Distillate Flow Rate | L/min | 1.70 | 1.40 | 1.40 | 1.80 | 1.60 |
| Condensate Level | % | 79.41 | 60.71 | 57.14 | 83.33 | 81.25 |
| Vapor Level | % | 20.59 | 39.29 | 42.86 | 16.67 | 18.75 |
| Feed Temperature | ° C. | 89 | 92 | 92 | 89 | 87 |
| Condensate Temperature | ° C. | 51 | 53 | 53 | 53 | 52 |
| Vapor Temperature | ° C. | 80 | 85 | 86 | 80 | 80 |
| Initial pH | — | 8.9 | 9.0 | 8.9 | 11.0 | 13.3 |
| Final pH | — | 9.0 | 9.6 | 9.6 | 10.7 | 12.3 |
| Initial NH₃—N Conc | mg/L | 972 | 1014 | 980 | 868 | 1155 |
| Final NH₃—N Conc | mg/L | 104 | 107 | 125 | 3 | 10 |
| Condensate NH₃—N Conc | mg/L | 724 | 644 | 778 | 437 | 582 |
| Initial NH₃ Conc | mg/L | 1182 | 1233 | 1192 | 1055 | 1404 |
| Final NH₃ Conc | mg/L | 126 | 130 | 152 | 4 | 12 |
| Condensate NH₃ Conc | mg/L | 880 | 783 | 946 | 531 | 708 |
| NH₃ in Initial Batch | moles | 2.637 | 2.751 | 2.659 | 2.355 | 3.133 |
| NH₃ in Final Batch | moles | 0.156 | 0.183 | 0.214 | 0.004 | 0.016 |
| NH₃ in Distillate | moles | 2.481 | 2.568 | 2.444 | 2.351 | 3.118 |
| NH₃ in Condensate | moles | 0.698 | 0.391 | 0.444 | 0.468 | 0.540 |
| NH₃ in Vapor | moles | 1.783 | 2.177 | 2.000 | 1.883 | 2.578 |
| Initial NH₃ Mole Fraction | — | 0.001250 | 0.001304 | 0.001260 | 0.001116 | 0.001485 |
| Final NH₃ Mole Fraction | — | 0.000134 | 0.000138 | 0.000161 | 0.000004 | 0.000013 |
| Distillate NH₃ Mole Fraction | — | 0.002629 | 0.003304 | 0.003146 | 0.002352 | 0.003510 |
| Condensate NH₃ Mole Fraction | — | 0.000931 | 0.000828 | 0.001001 | 0.000562 | 0.000749 |
| Vapor NH₃ Mole Fraction | — | 0.009179 | 0.007130 | 0.006005 | 0.011305 | 0.015478 |
| Initial NH₃ Wt Fraction | — | 0.001182 | 0.001233 | 0.001192 | 0.001055 | 0.001404 |
| Final NH₃ Wt Fraction | — | 0.000126 | 0.000130 | 0.000152 | 0.000004 | 0.000012 |
| Distillate NH₃ Wt Fraction | — | 0.002486 | 0.003124 | 0.002974 | 0.002224 | 0.003319 |
| Condensate NH₃ Wt Fraction | — | 0.000880 | 0.000783 | 0.000946 | 0.000531 | 0.000708 |
| Vapor NH₃ Wt Fraction | — | 0.008682 | 0.006743 | 0.005679 | 0.010694 | 0.014645 |
| % of Total Ammonia Stripped | % | 94.09 | 93.34 | 91.94 | 99.82 | 99.50 |
| % of Stripped Ammonia in Vapor | % | 71.88 | 84.78 | 81.82 | 80.09 | 82.67 |
| % of Stripped Ammonia in Condensate | % | 28.13 | 15.22 | 18.18 | 19.91 | 17.33 |

Actual Data

| | | | | | | |
|---|---|---|---|---|---|---|
| Distillate NH₃ Mole Fract-Actual | — | 0.002629 | 0.003304 | 0.003146 | 0.002352 | 0.003510 |
| Condensate NH₃ Mole Fract-Actual | — | 0.000931 | 0.000825 | 0.001001 | 0.000562 | 0.000749 |
| Vapor NH₃ Mole Fract-Actual | — | 0.009179 | 0.007130 | 0.006005 | 0.011305 | 0.015478 |
| Distillate NH₃ Wt Fraction-Actual | — | 0.002486 | 0.003124 | 0.002974 | 0.002224 | 0.003319 |
| Distillate NH₃ Wt Conc-Actual | wt % | 0.25 | 0.31 | 0.30 | 0.22 | 0.33 |
| Condensate NH₃ Wt Fraction-Actual | — | 0.000880 | 0.000783 | 0.000946 | 0.000531 | 0.000708 |
| Condensate NH₃ Wt Conc-Actual | mg/L | 880 | 783 | 946 | 531 | 708 |
| Vapor NH₃ Wt Fraction-Actual | — | 0.008682 | 0.006743 | 0.005679 | 0.010694 | 0.01465 |
| Vapor NH₃ Wt Conc-Actual | wt % | 0.87 | 0.67 | 0.57 | 1.07 | 1.46 |
| Vapor:Distillate NH₃ Conc Ratio | — | 3.49 | 2.16 | 1.91 | 4.81 | 4.41 |
| Vapor:Condensate NH₃ Conc Ratio | — | 9.86 | 8.61 | 6.00 | 20.11 | 20.68 |
| Vapor:Feed NH₃ Conc Ratio | — | 7.34 | 5.47 | 4.76 | 10.13 | 10.42 |
| % of Stripped Ammonia in Vapor | % | 71.88 | 84.78 | 81.82 | 80.09 | 82.67 |
| % of Stripped Ammonia in Condensate | % | 28.13 | 15.22 | 18.18 | 19.91 | 17.33 |

### Example 4

This example describes removal of a target chemical from a water stream using a membrane reactor system (a tangential flow hollow fiber filtration system), wherein the target chemical is ammonium/ammonia.

In this example, a feed comprising dissolved ammonia gas was provided to an membrane reactor system, wherein the membrane reactor system comprised a first region and a second region, wherein the first region and the second region were separated by a membrane. The membrane employed was a tangential flow hollow fiber filtration system, Liqui-Cel® Extra-Flow Membrane Contactor (Item #G492, X50 membrane, 4″×13″ Membrana-Charlotte, A Division of Celgard Inc., 13800 South Lakes Drive, Charlotte, N.C. 28273 USA).

In a first test, a solution comprising dissolved ammonia gas (e.g., as ammonia hydroxide) was flown through the first region at a flow rate between about 500 and 1400 cc/min. The pH of the first solution was between about 3.8 and about 12 and the inlet temperature for the ammonia solution was between about 135 and about 158 F. The outlet temperature for the first region was between about 44 and 52 F. The pressure was between about 12 and about 13 psi. A second solution, comprising sulfuric acid, was flown through the second region in a direction opposite to the flow in the first region. The flow rate in the second region was between about 3.6 and about 6.4 gallons per minute (gpm) and the pH at the inlet to the second region was between about 0.8 and about 3. The initial concentration of ammonium sulfate in the second solution was low (e.g., about 25 mg/L). As the solutions were flown in the two regions, the dissolved ammonia gas in the first solution in the first region passed through the membrane to the second region, wherein ammonium sulfate was formed. The concentration of ammonium sulfate in the second solution increased with time, the final concentration being about 181,000 mg/L after about 97 minutes. Simultaneously, the concentration of ammonia in the first solution decreased, wherein the original concentration was about 19,153 ppm and the final concentration was about 419 ppm. The solutions were flow for approximately 97 minutes. The total amount of solution provided to the first region was about 228.2 lbs. The total amount of solution provided to the second region was about 61.2 lbs.

A second test was carried out similarly to the first test, however, two membrane reactor systems connected in series were employed as well as the following operational modifications. The flow rate of the solution in the first region was between about 600 and 2920 cc/min. The pH of the first solution was between about 10.2 and about 10.7 and the inlet temperature for the ammonia solution was between about 90 and about 132 F. The pressure in the first region was about 11 psi. The flow rate in the second region was between about 2.5 and about 3.9 gpm and the pH at the inlet to the second region was between about 0.9 and about 1.4. The initial concentration of ammonium sulfate in the second solution was about 263,192 mg/L, and the final concentration was about 258,651 mg/L after about 109 minutes. Thus, this experiment shows that relatively high levels of ammonium sulfate production could be maintained over time. Simultaneously with ammonium sulfate production, the concentration of ammonia in the first solution decreased, wherein the original concentration was about 4506 ppm and the final concentration after being passed through the first membrane system was about 499 ppm (i.e., the first membrane output solution). The first membrane output solution was flowed into a second membrane reactor system positioned in series with the first membrane reactor, wherein the concentration of ammonia in the solution was further decreased to about 39 ppm. The solutions were flow for approximately 109 minutes. The total amount of solution provided to the first region was about 433 lbs. The total amount of solution provided to the second region was about 93 lbs.

### Example 5

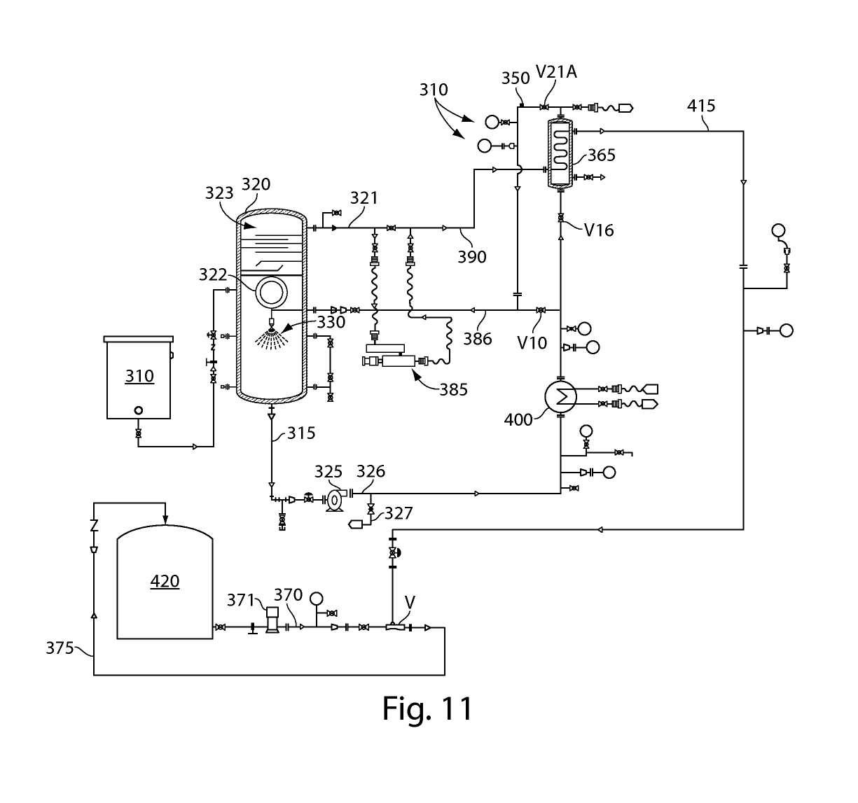

The following example describes an embodiment of a Turbo CAST® (Controlled Atmosphere Separation Technology) system and method, as illustrated in FIG. 11, used for the reduction of ammonia in a water stream. The system was operated at elevated temperatures to shift the ammonia/ammonium equilibrium.

Generally, the Turbo CAST® method is an approach for the reduction of ammonia from both biological and industrial waste streams. The technique involves four basic scientific principles: (1) heating the solution (process feed) to approximately 180-190 degrees Fahrenheit (F.), thereby shifting the ammonium/ammonia equilibrium in favor of ammonia gas and decreasing the dissolved ammonia gas solubility, (2) reducing the pressure of the containment with an applied vacuum thereby controlling the bottoms temperature and evacuating the vapor, (3) using a flash vacuum distillation approach that circulates and heats the process liquid exterior to the distillation column, and (4) utilizing a high efficiency mechanical vapor recompression step in the distillation process which allows recovery of the latent heat of the distillate and eliminates the need for a constant external heat source.

Ammonium/Ammonia equilibrium: As mentioned previously, a standard method for shifting the ammonium/ammonia equilibrium is increasing the pH with the use of a base (e.g., sodium hydroxide, lime, potassium hydroxide, etc.). FIG. 6A shows ammonia/ammonium percent of species as a function of pH of a solution, or relative ammonia/ammonium concentration in the solution as a function of pH of the solution. According to the graph of FIG. 6B, at 20 degrees Celsius (C), the equilibrium point of ammonium to ammonia is 9.3 pH units, meaning that at a pH of 9.3 at 20 degrees C. there is 50% ammonium and 50% ammonia in solution. As the pH is increased with the use of sodium hydroxide or another comparable base, ammonium concentrations decrease and ammonia concentration increases. At pH 11.5, the ammonia concentration approaches 100% while ammonium concentration approaches zero. It is important to note that most ammonia received by municipal treatment plants is in the form of ammonium bicarbonate and must be converted to ammonia gas before stripping processes can be employed.

Increasing the temperature of an ammonium bearing solution results in shifting the ammonium/ammonia equilibrium toward lower pH values. The graph of FIG. 6A illustrates the equilibrium shift at varying temperatures. As the temperature increases, the pH required to reach equilibrium conditions is shifted toward lower pH values. At 0 degrees C. the equilibrium point is pH 10, at 20 degrees C. the equilibrium point is pH 9.3, at 40 degrees C. the equilibrium point is pH 8.7. The amount of heat required to shift the equilibrium for a given waste stream is dependent on the following variables: pH of the incoming stream, the solutions temperature and buffering capacity. The Thermal Turbo CAST® process operates between approximately 160 degrees F. and approximately 250 degrees F. (approximately 82-87 degrees C.) in order to compensate for variables highlighted above. The higher operational temperature substantially decreases or in some cases eliminates the need for sodium hydroxide to convert ammonium to ammonia.

Mechanical Vapor Recompression: Mechanical vapor recompression evaporator technology has been used for over 100 years and is a proven means to significantly reduce energy required for evaporation. In the Thermal Turbo CAST® process embodiment shown in FIG. 11, the ammonia containing solution is initially heated with an external heat source such as one or more heat exchangers 400 to the boiling point of the liquid. Once boiling point is achieved, the external heat source 400 is decoupled from the system. As ammonia and water vapor pass out of a Turbo CAST® vessel distillation tower 320, the stream 321 is compressed by an inline rotary blower (compressor) 385. Compressing the water and ammonia vapor 321 raises the pressure and saturation temperature of the combined vapor to form combined vapor stream 390 so that it may be returned to the heat exchanger (condenser) 365 to be used as heating steam. The heat present in the vapor 390 can then be used to evaporate more water/ammonia mixture instead of being rejected to the cooling medium within the condenser 365.

The compression energy supplied by the blower 385 is of the same magnitude as the energy required to increase the feed temperature to the boiling point. It therefore becomes possible to operate the Thermal Turbo CAST® with little or no makeup heat given proper heat exchange exists between the condensate and process feed. The heat energy is caused by the compressor 385.

The main advantage of vapor recompression is significantly lower energy consumption. The energy savings is a net result of the thermodynamics of the process. Vapor compression has proven to be a reliable method of achieving low energy evaporation when the system is properly engineered and operated.

Technology Description: A process flow diagram of a method of embodiments of an ammonia recovery process and of an ammonia recovery system of embodiments is depicted in FIG. 11. The feed solution is preheated ahead of a feed tank 310 which supplies the influent F to the operating system at the design operating temperature. Given the variability of most process streams, the use of a minimal amount of a base such as sodium hydroxide may or may not be required depending on the initial pH of the solution and the corresponding buffer capacity. If sodium hydroxide addition is warranted, NaOH solution (or another base) is added via a chemical metering pump either at the process cone bottom tank or injected into the process feed recirculation loop. pH may be controlled and monitored using a conventional pH probe and associated transmitter/controller.

The solution to be processed is either pumped or drawn into the system from the feed tank 310 by the vacuum maintained on the process vessel 320. The process feed F enters the process vessel 320 above the process solution liquid level and at or near the spray cone 330. The introduction of feed solution F to the process vessel is completely automatic and controlled, for example by a series of floats located in an externally mounted sight glass 322. The process solution is maintained within a level range within the process vessel 320. The sight glass allows the operator to view the actual liquid level in the process vessel 320.

The process solution exits the lower portion of the process vessel 320 as a saturated liquid 315. The saturated process solution 315 enters the concentration pump 325 and exits as a compressed liquid 326. A slight increase in temperature occurs due to the heat transfer between the pump 325 and the process solution. The actual increase in temperature is a function of the type of pump used and the wire-to-water efficiency of the pump. In all instances, the heat gained by the process solution from the pump 325 is beneficial to the process, although usually insignificant.

The stripped liquid discharge line is located ahead of the lower instrumentation manifold on the concentrate pump discharge line. The discharge function can be controlled by an in-line ammonia sensor, or by interval timers, or as per operator determination. The stripped process solution 327 is discharged under pressure, and may be returned directly to the process or to an approved storage tank for recovery, recycle or permitted disposal.

The cooling water in the condenser 365 is recirculated still bottoms (referring to the still bottoms of the process vessel 320), which receives the latent heat from the condensed vapor 390.

The heated and pressurized solution 350 exits a heat exchanger (condenser) 365 and enters an upper instrumentation manifold 410. The heated and pressurized process solution exits the upper instrumentation manifold 410 and enters the process vessel 320 through a spray head 330 located in the center of the process vessel 320. The spray head 330 produces a conical spray pattern, thus increasing the effective surface area available for evaporation, while imparting a downward velocity to the process solution. The spray head 330 is a spiral type designed to prevent clogging and may be constructed of virtually any material. It is very important to note that the evaporation occurs within the spray cone 330 and not at the interface of a heated surface. This is commonly referred to as flash distillation, as opposed to nucleate boiling or thin film.

Once the boiling point of the liquid is achieved using the primary heat exchanger 400, the heat source is decoupled from the system. A portion of the sprayed process solution evaporates with the liberated ammonia gas and travels upward through the process vessel 320 to the section containing liquid/vapor separation baffles 323 (which act as mist eliminators by providing a tortuous path through which the vapor to travel at a speed of, for example, 322 feet per second). The higher boiling point contaminants and a percentage of the process solution do not evaporate. This material possesses a downward velocity imparted by the spray head 330, and is collected at the bottom (still bottoms) of the process vessel 320. A small percentage of process solution and contaminants become entrained by the raising vapor (commonly referred to as carry-over). The quantity entrained is a function of the vapor and process solution relative viscosity, velocity and density. The baffles 323 strip the carry-over from the raising vapor. The stripped carry over falls back to the spray cone area and is entrained by the non-evaporated process solution. This material is collected at the bottom (still bottoms) of the process vessel 320 and re-circulated into the process vessel 320 (e.g., via streams 315 and 386).

The ammonia and water vapor 321 pass through the liquid separation baffles and the upper portion of the process vessel (vapor dome) 320 and enter the compressor 385.

The compressor 385 pressurizes the 160-190 degrees F. (approximately) water/ammonia vapor mixture 321 and imparts an additional 30-60 degrees F. of heat (approximately), thereby raising the vapor mixture temperature to 210-250 degrees F. (approximately). The superheated vapor 390 then passes through the heat exchanger (the condenser) 365. Process fluid to be heated is redirected through the condenser 365 via a transfer manifold (e.g., valves V16, V10, and V21A, which are manipulated to redirect the process fluid). The superheated steam 390 generated by the compressor 385 transfers its heat to the process feed, increasing the temperature to the boiling point. The heating process is therefore completely self-sustained by the increase in the vapor saturation temperature (Delta T) provided by the compressor 385. No additional heat is provided to the liquid.

The water/ammonia saturated vapor 390 is then condensed to a saturated liquid and sub-cooled in the condenser 365. The ammonia is partially dissolved in the saturated liquid (water) and the remainder exists as gas.

The condensate 415 exits the condenser 365 and enters the venturi V. The venturi V is used to initialize and maintain the vacuum on the process of vessel 320 in addition to removing the ammonia/water mixture. The venturi V is motivated by a pumped solution 370 (e.g., via pump 71) of sulfuric acid and water. As the liquid water and ammonia vapor 415 enter the venturi V, a chemical reaction takes place between the liquid water and ammonia vapor 415 and the sulfuric acid/water solution 370 converting the dissolved and free ammonia gas into ammonium sulfate 375. Ammonium sulfate is a fertilizer with established agronomic value. The ammonium sulfate 375 may be delivered to an ammonium sulfate collection tank 420, and at least a portion of the tank 420 contents may be recirculated as the sulfuric acid/water solution 370 which enables the chemical reaction to take place in the venturi V.

The venturi V functions to pull a vacuum on the entire ammonia recovery system. The venturi V and its recirculating streams and pump 371 constitute a closed loop system for generating a vacuum. The closed loop system creates a vacuum on the system and converts ammonia to valuable fertilizer. Use of a vacuum on the system to remove pressure from the system decreases the boiling point of the system so that the boiling point of water is approximately 140 degrees F. to approximately 150 degrees F., much lower than the ordinary boiling point of water during typical pressure conditions. Lowering the boiling point of water via vacuum on the system permits system components to be made out of plastics and not metal because plastics will not melt at the lowered boiling point of 140-150 degrees F. (but will melt at the typical boiling point of water under ordinary pressure conditions).

Thermal Turbo CAST® Pilot Studies: Pilot studies have been conducted by applicant to demonstrate efficacy of the technology. Studies were conducted using synthetic feed stock (a mixture of ammonium bicarbonate and deionized water), agricultural derived digestates and actual municipal centrate samples. The studies demonstrated that only one third of the stoichiometric amount of sodium hydroxide was required to remove 80-90% of the dissolved ammonia for each matrix type evaluated. The Thermal Turbo CAST® approach utilizes vapor recompression to achieve heating of the process stream.

Conclusion: Embodiments disclosed in this example include new energy-efficient technology which lowers operating costs for wastewater treatment and recovery, for example. Embodiments include a wastewater recovery system and method having energy efficient, high-flow technology. Embodiments of the process and system described in this example may be specifically designed for use in areas where energy costs are high and in applications where there are high wastewater flows. Embodiments incorporate the latest in heat recuperation technology that allows for the recovery of up to 90% of the thermal energy used in the system. By combining vapor recompression technology with a vacuum assisted flash distillation process, embodiments provide a highly energy efficient, very simple to operate system and method that reduces operating costs.

The process and system of this example may be incorporated into many wastewater recovery systems which recover components from wastewater including ammonia, metals, biochemical oxygen demand (BOD), and glycol. Embodiments in this example have high-uptime, low-maintenance costs and a small footprint. In addition, Turbo CAST® embodiments disclosed herein may be retrofit to other CAST® systems known to those skilled in the art or other CAST® systems disclosed in U.S. Pat. No. 7,270,796, U.S. Patent Publication Number 2007/0297953 A1, U.S. Pat. No. 4,770,748, or U.S. Pat. No. 4,880,504 which are incorporated by reference herein above, improving the energy performance of these systems significantly. Embodiments in this example disclosed herein may also be retrofit to Thermo CAST® technology (a traditional CAST® process run at very high temperatures, e.g., 190-200 degrees F. under vacuum past boiling point), traditional CAST® technology (traditional process is run at temperatures of 120-140 degrees F.), or Mobile CAST® technology (mobile version of a CAST® system). System embodiments disclosed in this example are the most cost-effective solutions for the secondary treatment of wastewater and the recovery of process chemistry.

Embodiments disclosed in this example increase system efficiency and decrease operational costs as compared to a standard distillation by turbo-charging the system using the compressor or blower.

### Example 6

This example describes a Thermal R-CAST® Ammonia Recovery Process (ARP) system in which process calculations and simulations were performed using commercially-available software (Microsoft Excel). The Thermal R-CAST® Ammonia Recovery Process (ARP) system is a physical-chemical based wastewater treatment technology that efficiently vacuum flashes/strips ammonia from wastewater streams at elevated temperature and recovers the ammonia in the form of ammonium by-products. Thermal R-CAST® ARP is a based upon flash vacuum evaporator/distillation technologies.

In order for ammonia to be vacuum flashed/stripped, it is generally converted to a soluble, gaseous state. This conversion is governed by the following ammonium ion-ammonia equilibrium reaction whereby the ammonium ion (NH₄⁺) reacts with a hydroxyl ion (OH⁻):

NH₄⁺+OH⁻ [symbol] NH₃ (g)+H₂O (1)

The dissociative ammonium ion (NH₄⁺) to ammonia (NH₃) equilibrium shift employed in the R-CAST® ARP is favored by both increasing pH and temperature. Thus, the reversible equilibrium reaction can be driven forward or backward by varying the pH and temperature of the wastewater.

With conventional low temperature (typically less than 40° C.) R-CAST® ARP operation, the equilibrium shifts almost completely to the ammonium ion at pH less than or equal to 7.0, rendering the flashing/stripping process ineffective. At a pH greater than or equal to 11.3, the equilibrium favors the formation of almost all free ammonia gas. Under this condition, the ammonia can be readily flashed/stripped and recovered from the wastewater solution. In many systems, a substantial amount of sodium hydroxide or other suitable base is provided to increase the wastewater pH necessary for the conversion to ammonia gas.

This Thermal R-CAST® ARP approach takes advantage of elevated temperature (typically 65 to 85° C.) to shift the ammonia (NH₃) gas vs. pH equilibrium relationship to the left thereby converting ammonium ion (NH₄⁺) to ammonia (NH₃) at lower pH as shown below. Therefore, increasing the process temperature above 65° C. to shift the equilibrium curve enables the flashing/stripping process to be operated at a significantly lower pH level. As a result, lower pH operation substantially reduces or in some cases, eliminates the sodium hydroxide operating cost.

The sodium hydroxide requirement depends on both the ammonium ion concentration and bicarbonate alkalinity (typically as sodium and/or ammonium) of the wastewater feed to the Thermal R-CAST® ARP system. Due to the buffering effect of the bicarbonate alkalinity, the total sodium hydroxide requirement can highly exceed the stoichiometric amount required for the conversion of ammonium to ammonia at the operating pH. The requirement of base is governed by the following reactions:

Ammonium Ion Reaction: NH₄⁺+NaOH→NH₃+H₂O+Na⁺

Bicarbonate Alkalinity Reactions: NaHCO₃+NaOH→Na₂CO₃+H₂O

NH₄HCO₃+2NaOH→Na₂CO₃+NH₃+2H₂O

Ammonium bicarbonate decomposes at 36 to 60° C. into ammonia, carbon dioxide, and water vapor in an endothermic process according to the following reaction:

NH₄HCO₃→NH₃+CO₂+H₂O

The Thermal R-CAST® ARP technology also may convert the bicarbonate alkalinity to carbon dioxide enabling CO₂ sequestration as a separate process step as another benefit.

In addition to enabling lower pH operation, high temperature increases the volatility and reduces the solubility of ammonia gas in the wastewater. The increased volatility and reduced solubility of the ammonia gas in wastewater at elevated temperature increases the rate of the ammonia flashing/stripping process. Thus, high temperature operation can reduce the vessel size and associated capital equipment costs.

The high operating temperature of the Thermal R-CAST® ARP system also allows for staging of vessels in multi-effect fashion whereby the heat of operation of each serially-staged vessel is derived from the prior vessel's flashed distillate. This multi-effect staging of vessels results in a reduction in the heat energy requirement and associated operating cost. This type or extent of heat energy recovery is generally not feasible with conventional low temperature technologies.

### System Description

In an exemplary embodiment, the Thermal R-CAST® ARP wastewater treatment process comprises the following three serial unit operations to remove and recover the ammonia as ammonium sulfate:

Two-stage R-CAST® Vacuum Distillation (ammonia removal)

Membrane Degasification (ammonia sulfate pre-concentration)

Single-Stage CAST® Vacuum Evaporation (ammonium sulfate concentration)

The ammonia is removed from the ammonia-bearing wastewater by dual R-CAST® distillation vessels and recovered in water as a dilute ammonium hydroxide solution. Ammonia is removed from the dilute ammonium hydroxide solution by a membrane de-gasification module and recovered by reacting with sulfuric acid (e.g., to produce at least 20 wt % ammonium sulfate). The ammonium sulfate solution can be further concentrated by a CAST® evaporator unit, which is exported from the system. The ammonia-depleted R-CAST® bottoms effluent is discharged and handled accordingly.

Two-Stage R-CAST® Vacuum Distillation: Ammonia-bearing wastewater is supplied to the Thermal R-CAST® ARP wastewater treatment system. The wastewater is introduced into the dual R-CAST® vacuum distillation vessels in parallel operation on a semi-continuous basis upon demand. The wastewater is pressurized and circulated through the vessels by the process solution pumps. The pressurized, circulating wastewater is heated in-line to high temperature to partially convert soluble ammonium to ammonia gas. The heated wastewater is pH adjusted in-line with 50 wt % sodium hydroxide to convert the remaining ammonium to ammonia gas. The heated, pH adjusted wastewater is sprayed into the R-CAST® process vessels. The ammonia gas is liberated and removed from the wastewater under vacuum generated by a venturi ejector.

The ammonia gas is drawn through a baffle system at the top of the process vessels to control wastewater carry over. The ammonia gas is drawn from the baffles into the collection system under vacuum generated by a venturi ejector. The ammonia-water distillate is condensed to concentrate the ammonia vapor and reduce the water vapor volume. The condensed ammonia-water distillate is recovered in a tank as a dilute ammonium hydroxide solution in a circulating water solution that motivates the venturi vacuum ejector. The dilute ammonium hydroxide solution is periodically discharged from the tank to the membrane de-gasification/pre-concentration unit feed tank. The R-CAST® ammonia-depleted bottoms wastewater effluent is periodically discharged from system.

As an energy conservation measure, the heat required to operate the second stage R-CAST® vessel is derived from the first stage R-CAST® vessel. The circulating bottoms from the second stage R-CAST® vessel condenses the first stage R-CAST® distillate to acquire the heat necessary for operation prior to being sprayed into the vessel. This staging configuration decreases the theoretical heating demand substantially, thereby reducing the overall energy demand of the system.

Membrane Degasification using a membrane reactor system: A dilute ammonium hydroxide solution is collected in a feed tank. The ammonium hydroxide is pumped from the feed tank and pH adjusted in-line using 50 wt % sodium hydroxide. The pH control system can maintain a specific pH of the wastewater before entering the membrane degassing units. The pH adjusted ammonium hydroxide solution is fed to the membrane degassing unit consisting of multiple modules operating in a parallel arrangement. The pH adjusted ammonium hydroxide solution flows through one side of the membrane cartridges.

A sulfuric acid solution is circulated counter-currently on the opposite side of the membrane cartridges. The ammonia vapor diffuses across the membrane and reacts with the sulfuric acid solution to form a dilute ammonium sulfate solution. The dilute ammonium sulfate solution is collected in a separate tank. Sulfuric acid is periodically injected in-line to maintain the sulfuric acid concentration at the level needed to convert the ammonia gas to ammonium sulfate. Optionally, the dilute ammonium sulfate solution is periodically discharged to a CAST® evaporator ammonium sulfate concentrate tank. The degassed ammonium hydroxide effluent stream is continuously discharged from the system.

CAST® Vacuum Evaporation: The dilute ammonium sulfate solution is collected in the ammonium sulfate concentrate tank. The concentrated ammonium sulfate solution is periodically pumped into the CAST® vessel. The solution is pressurized and circulated though the vessel by a process pump. The pressurized, circulating solution is heated in-line to evaporate the water. The heated solution is sprayed into the CAST® unit process vessel. The water vapor is liberated and removed from the ammonium sulfate solution under vacuum generated by a venturi ejector to concentrate the solution.

The water vapor is drawn through a baffle system at the vessel top to minimize ammonium sulfate carry over. The water vapor is condensed to reduce the water vapor volume prior to distillate recovery. The water vapor-condensate is recovered in the CAST® distillate collection tank as low TDS product water that circulates to motivate the venturi vacuum ejector. The low TDS distillate water is periodically discharged from the distillate collection tank. The ammonium sulfate CAST® solution (e.g., 40 wt %) is periodically exported from the concentrate tank to storage and hauling.

As an energy conservation measure, the heat required to operate the CAST® vessel is derived from the second stage R-CAST® vessel. The circulating bottoms from the CAST® vessel condenses the second stage R-CAST® distillate to acquire the heat necessary for operation prior to being sprayed into the vessel. This staging configuration decreases the theoretical heating demand substantially, thereby reducing the overall energy demand of the system.

Wastewater Treatment Process Integration: The Thermal R-CAST® ARP technology can be integrated with a variety of other wastewater treatment methods in order to optimize its performance and efficiency. These wastewater treatment methods may include, but are not limited to dissolved air flotation (DAF); multi-media filtration; ultraviolet (UV) irradiation; ion exchange softening; ultrafiltration (UF); and/or reverse osmosis (RO).

Conclusions: Thermal R-CAST® ARP technology whether stand-alone or deployed with other strategic wastewater treatments technologies improves and advances the state-of-the art of the conventional ammonia recovery from wastewater technologies.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for producing a desired product from wastewater or process water, comprising:
providing wastewater or process water comprising a target chemical;
vaporizing at least a portion of the wastewater or process water to form a vapor portion, which vapor portion contains the target chemical and/or a chemically modified form thereof;
forming a first liquid solution containing the target chemical and/or the chemically modified form thereof;
introducing at least a portion of the first liquid solution into a first region of a membrane reactor system comprising the first region and a second region, wherein the first and second regions are separated by a membrane, and wherein the second region contains a second liquid solution comprising a reagent reactive with the target chemical and/or the chemically modified form thereof;
reacting at least a portion of the target chemical and/or the chemically modified form thereof with the reagent to form the desired product in the second region of the membrane reactor system; and
collecting the desired product.

2. A system for recovering a desired product from wastewater or process water, comprising:
a vaporizer adapted and arranged to vaporize a portion of the wastewater or process water and produce a vapor stream containing a target chemical and/or the chemically modified form thereof;
a condenser in fluid communication with the vaporizer and adapted and arranged to form a liquid solution containing the target chemical and/or the chemically modified form thereof;
a membrane reactor system in fluid communication with the gas collection system and comprising a first region and a second region, wherein the first and second regions are separated by a membrane and adapted to facilitate a reaction between the target chemical and/or the chemically modified form thereof and a reagent to form the desired product; and
a collection system in fluid communication with the membrane reactor system and adapted and arranged to collect the desired product.

3. A method for producing an ammonium product from wastewater or process water, comprising:
providing wastewater or process water comprising ammonium;
converting the ammonium to ammonia gas to form a solution comprising dissolved ammonia gas; and
contacting the solution comprising the dissolved ammonia gas with an acid solution to form an ammonium salt solution,
wherein the concentration of ammonium salt is greater than or equal to about 20 wt % immediately following the contacting step.

4. A method for recovering ammonia from wastewater or process water, comprising:
increasing the temperature of wastewater or process water comprising ammonium to between about 160 F and about 200 F and adjusting the pH of the wastewater to between about 7.5 and 11, thereby converting a substantial portion of the ammonium to ammonia gas;
forming a vapor portion containing a substantial portion of the ammonia gas from the wastewater in a vaporizer, wherein the vaporizer is operated at a pressure between about 6 and 21 inches Hg vacuum; and
collecting the ammonia gas.

5. A method for producing a desired product from wastewater or process water, comprising:
introducing wastewater or process water containing a target chemical into a reverse osmosis system and forming a retentate comprising a de-watered, more concentrated solution of the target chemical;
optionally converting the target chemical from the retentate into a chemically modified form thereof;
introducing at least a portion of the retentate from the reverse osmosis system into a first region of a membrane reactor system comprising the first region and a second region, wherein the first and second regions are separated by a membrane, and wherein the second region contains a liquid solution comprising a reagent reactive with the target chemical and/or the chemically modified form thereof;
reacting at least a portion of the target chemical and/or the chemically modified form thereof with the reagent to form the desired product in the second region of the membrane reactor system; and
collecting the desired product.

6. An apparatus for producing a desired product from wastewater or process water, comprising:
a reverse osmosis system adapted and arranged to concentrate and/or purify a target chemical in the wastewater or process water and form a retentate comprising a de-watered, more concentrated solution of the target chemical;
a membrane reactor system in fluid communication with the reverse osmosis system and comprising a first region and a second region, wherein the first and second regions are separated by a membrane and adapted to facilitate a reaction between the target chemical and/or a chemically modified form thereof and a reagent to form the desired product in the second region; and
a collection system in fluid communication with the membrane reactor system and adapted and arranged to collect the desired product.

7. A method for producing a chemically modified form of a target chemical from wastewater or process water, comprising:
introducing wastewater or process water containing a target chemical into a reverse osmosis system and forming a retentate comprising a de-watered, more concentrated solution of the target chemical;
converting a substantial portion of the target chemical in the retentate from the reverse osmosis system into a chemically modified form of the target chemical;
vaporizing at least a portion of the retentate to form a vapor portion, which vapor portion contains the chemically modified form of the target chemical; and
collecting the chemically modified form of the target chemical in a first solution.

8. An apparatus for producing a chemically modified form of a target chemical from wastewater or process water, comprising:
a reverse osmosis system adapted and arranged to concentrate and/or purify a target chemical in wastewater or process water and form a retentate comprising a de-watered, more concentrated solution of the target chemical;
a reaction and separation system adapted and arranged to convert a substantial portion of the target chemical into a vapor containing a chemically modified form of the target chemical; and
a collection system adapted and arranged to collect the chemically modified form of the target chemical.

9. The method of claim 1, wherein the target chemical and/or the chemically modified form thereof is a gas or a dissolved gas.

10. The method of claim 1, wherein the target chemical is ammonium.

11. The method of claim 1, wherein the chemically modified form of the target chemical is ammonia gas or dissolved ammonia gas.

12. The method of claim 1, wherein the chemically modified form of the target chemical is dissolved ammonia gas present in water in the form of ammonium hydroxide and/or ammonium bicarbonate.

13. The method of claim 1, wherein the reagent is an acid.

14. The method of claim 13, wherein the acid is an organic acid or an inorganic acid.

15. The method of claim 13, wherein the acid is sulfuric acid, phosphoric acid, citric acid, nitric acid, hydrochloric acid, or acetic acid.

16. The method of claim 13, wherein the acid is sulfuric acid.

17. The method of claim 1, wherein the product is an ammonium salt.

18. The method of claim 1, wherein the product is (NH₄)₂SO₄.

19. The method of claim 5, wherein the target chemical from the retentate is converted into a chemically modified form thereof.

20. The method of claim 1, wherein the vaporizing is carried out using a reaction and separation system.

21-48. (canceled)
